(19) United States
(12) Patent Application Publication
(10) Pub. No.: US 2017/0142687 A1
(43) Pub. Date: May 18, 2017

(54) COMMUNICATION METHOD, ELECTRONIC DEVICE AND STORAGE MEDIUM

(71) Applicant: SAMSUNG ELECTRONICS CO., LTD., Suwon-si, Gyeonggi-do (KR)

(72) Inventors: Hye-Jeong KIM, Suwon-si, Gyeonggi-do (KR); Sung-Jin PARK, Seoul (KR)

(21) Appl. No.: 15/317,217

(22) PCT Filed: Jun. 8, 2015
(86) PCT No.: PCT/KR2015/005725

§ 371 Date: Dec. 8, 2016

(30) Foreign Application Priority Data
Jun. 20, 2014 (KR) 10-2014-0076069

(51) Int. Cl. H04W 72/02; H04W 72/04; H04W 72/08

(52) U.S. Cl. CPC H04W 72/02; H04W 72/082; H04W 72/0453; H04W 72/042

(57) ABSTRACT

According to various examples of the present invention, an electronic device communication method comprises the operations of: acquiring first configuration information on a first communication operation of a first communication module arranged in the electronic device; acquiring second configuration information on a second communication operation of a second communication module arranged in the electronic device; selecting one from among a plurality of pieces of predetermined control information for controlling the second communication operation on the basis of the first configuration information and/or the second configuration information; and limiting the second communication operation on the basis of the selected control information.

### TECHNICAL FIELD

Various embodiments of the present invention relate to an electronic device having a communication function, for example, a method and an apparatus for performing communication using a plurality of communication modules.

### BACKGROUND ART

Electronic devices (for example, smart phones) may include a plurality of communication modules to support various communication schemes, for example, Wi-Fi, Wi-Fi direct, Bluetooth (BT), Near Field Communication (NFC), a Global Positioning System (GPS), cellular communication (for example, Long-Term Evolution (LTE), LTE Advanced (LTE-A), Code division multiple access (CDMA), Wideband CDMA (WCDMA), Universal Mobile Telecommunications System (UMTS), Wireless Broadband (WiBro), Global System for Mobile Communications (GSM), and the like), and the like.

### DETAILED DESCIPTION OF THE INVENTION

### Technical Problem

A B40 frequency band (that is, 2300 to 2400 MHz) used in LTE and an

Industrial, Scientific, and Medical (ISM) band (2400 to 2500 MHz) used in Wi-Fi or Bluetooth are adjacent to each other.

For example, when a first communication module that performs LTE communication using the B40 frequency band and a second communication module that performs Wi-Fi communication using the ISM frequency band are adjacent to each other within one electronic device, a transmitted signal of one of the first and second communication modules gives interference to a received signal of the other communication module.

Due to such signal interference, a reception capability of the other communication module significantly deteriorates. Even when signal transmission of one of the first and second communication modules is stopped to avoid the signal interference, a communication capability of one of the communication modules significantly deteriorates.

Various embodiments of the present invention may provide a communication method and apparatus to solve the above described problems or other problems.

### Technical Solution

According to various embodiments of the present invention, a method of performing communication by an electronic device is provided. The method includes: acquiring first setting information of a first communication operation of a first communication module arranged within the electronic device; acquiring second setting information of a second communication operation of a second communication module arranged within the electronic device; selecting one of a plurality of pieces of predetermined control information for controlling the second communication operation based on at least one piece of the first setting information and the second setting information; and limiting the second communication operation based on the selected control information.

According to various embodiments of the present invention, an electronic device is provided. The electronic device includes: a first communication module that performs a first communication operation; and a second communication module that performs a second communication operation, wherein the electronic device acquires first setting information of a first communication operation, acquires second setting information of a second communication operation, selects one of a plurality of pieces of predetermined control information for controlling the second communication operation based on at least one piece of the first setting information and the second setting information, and limits the second communication operation based on the selected control information.

### Effects of the Invention

According to various embodiments of the present invention, capability degradation due to signal interference can be minimized in first and second communication modules using adjacent frequency bands.

### BRIEF DESCRIPTION OF THE DRAWINGS

FIG. 1 illustrates a network environment including an electronic device according to various embodiments of the present invention;

FIG. 2 is a block diagram illustrating a communication control module of an electronic device according to various embodiments of the present invention;

FIG. 3 illustrates a communication control system according to various embodiments of the present invention;

FIG. 4 illustrates a communication control method of a communication control system according to various embodiments of the present invention;

FIG. 5 is a flowchart illustrating a communication control method according to various embodiments of the present invention;

FIG. 6 illustrates a communication control method according to various embodiments of the present invention;

FIG. 7 is a flowchart illustrating a communication control method according to various embodiments of the present invention;

FIG. 8 illustrates a communication control method according to various embodiments of the present invention;

FIG. 9 is a flowchart illustrating a communication control method according to various embodiments of the present invention; and

FIG. 10 is a block diagram of an electronic device according to various embodiments of the present invention.

### MODE FOR CARRYING OUT THE INVENTION

Hereinafter, various embodiments of the present invention will be described with reference to the accompanying drawings. The present invention may be modified in various forms and include various embodiments, but specific examples are illustrated in the drawings and described in the description. However, the description is not intended to limit the present invention to the specific embodiments, and it shall be appreciated that all the changes, equivalents and substitutions belonging to the idea and technical scope of the present invention are included in the present invention. In connection with descriptions of the drawings, like reference numerals designate like elements.

The term “include” or “may include” refers to the existence of a corresponding disclosed function, operation or component which can be used in various embodiments of the present invention and does not limit one or more additional functions, operations, or components. In the present invention, the terms such as “include” or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof

The term “or” as used in various embodiments of the present invention includes any or all of combinations of listed words. For example, the expression “A or B” may include A, may include B, or may include both A and B.

The expression “1”, “2”, “first”, or “second” used in various embodiments of the present invention may modify various components of various embodiments but does not limit the corresponding components. For example, the above expressions do not limit the sequence and/or importance of the elements. The above-described expressions may be used to distinguish an element from another element. For example, a first user device and a second user device indicate different user devices although both of them are user devices. For example, without departing from the scope of the present invention, a first component element may be named a second component element. Similarly, the second component element also may be named the first component element.

It should be noted that if it is described that one component element is “coupled” or “connected” to another component element, the first component element may be directly coupled or connected to the second component, and a third component element may be “coupled” or “connected” between the first and second component elements. Conversely, when one component element is “directly coupled” or “directly connected” to another component element, it may be construed that a third component element does not exist between the first component element and the second component element.

The terms in various embodiments of the present invention are used to describe a specific embodiment, and are not intended to limit the present invention. As used herein, the singular forms are intended to include the plural forms as well, unless the context clearly indicates otherwise.

Unless defined differently, all terms used herein, which include technical terminologies or scientific terminologies, have the same meaning as that understood by a person skilled in the art to which the present invention belongs. Such terms as those defined in a generally used dictionary are to be interpreted to have the meanings equal to the contextual meanings in the relevant field of art, and are not to be interpreted to have ideal or excessively formal meanings unless clearly defined in the present invention.

An electronic device according to various embodiments of the present invention may be a device with a communication function. For example, the electronic device may include at least one of a smart phone, a tablet personal computer (PCs), a mobile phone, a video phone, an e-book reader, a desktop PC, a laptop PC, a netbook computer, a personal digital assistant (PDA), a portable multimedia player (PMP), a MP3 player, a mobile medical device, a camera, a wearable device (e.g., head-mounted-device (HMD) such as electronic glasses, electronic clothes, an electronic bracelet, an electronic necklace, an electronic appcessory, an electronic tattoo, or a smart watch).

According to some embodiments, the electronic device may be a smart home appliance with a communication function. The smart home appliances may include at least one of, for example, televisions, digital video disk (DVD) players, audio players, refrigerators, air conditioners, cleaners, ovens, microwaves, washing machines, air purifiers, set-top boxes, TV boxes (e.g., HomeSync™ of Samsung, Apple TV™, or Google TV™), game consoles, electronic dictionaries, electronic keys, camcorders, or electronic frames.

According to some embodiments, the electronic device may include at least one of various medical appliances (e.g., Magnetic Resonance Angiography (MRA), Magnetic Resonance Imaging (MRI), Computed Tomography (CT) machine, and an ultrasonic machine), navigation devices, Global Positioning System (GPS) receivers, Event Data Recorders (EDRs), Flight Data Recorders (FDRs), automotive infortainment devices, electronic equipments for ships (e.g., navigation equipments for ships, gyrocompasses, or the like), avionics, security devices, head units for vehicles, industrial or home robots, Automatic Teller Machines (ATM) of banking facilities, and Point Of Sales (POSs) of shops.

According to some embodiments, the electronic device may include at least one of furniture or a part of a building/structure, an electronic board, an electronic signature receiving device, a projector, and various types of measuring devices (for example, a water meter, an electric meter, a gas meter, a radio wave meter and the like) including a camera function. An electronic device according to various embodiments of the present invention may be a combination of one or more of above described various devices. Also, an electronic device according to various embodiments of the present invention may be a flexible device. Also, an electronic device according to various embodiments of the present invention is not limited to the above described devices.

Hereinafter, an electronic device according to various embodiments will be described with reference to the accompanying drawings. The term “user” used in various embodiments may refer to a person who uses an electronic device or a device (for example, an artificial intelligence electronic device) that uses an electronic device.

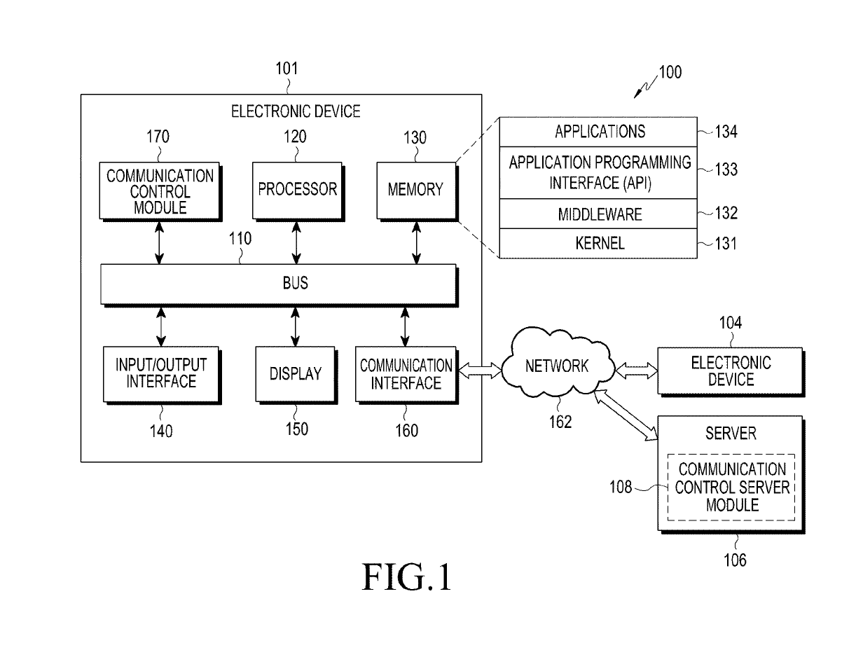

FIG. 1 illustrates a network environment 100 including an electronic device 101 according to various embodiments of the present invention. Referring to FIG. 1, the electronic device 101 may include a bus 110, a processor 120, a memory 130, an input/output interface 140, a display 150, a communication interface 160, and a communication control module 170.

The bus 110 may be a circuit to connect the above-described component elements with one another and to transfer communication (for example, control messages) among the above-described elements.

For example, the processor 120 may receive instructions, through the bus 110, from the aforementioned other components (for example, the memory 130, the input/output interface 140, the display 150, the communication interface 160, and the communication control module 170), decipher the received instructions, and perform calculation or data processing according to the deciphered instructions. The memory 130 may store instructions or data received from the processor 120 or other components (for example, at least one of the input/output interface 140, the display 150, the communication interface 160 and the communication control module 170) or generated by the processor 120 or other components. The memory 130 may include programming modules such as, for example, a kernel 131, middleware 132, an Application Programming Interface (API) 133, or applications 134. Each of the aforementioned programming modules may be formed of software, firmware, hardware, or a combination of at least two thereof.

The kernel 131 may control or manage system resources (for example, at least one of the bus 110, the processor 120, the memory 130 and the like) which are used for performing operations or functions implemented by other programming modules, for example, the middleware 132, the API 133 or the applications 134. Further, the kernel 131 may provide an interface through which the middleware 132, the API 133, and the applications 134 may access individual components of the electronic device 101 to control or manage them.

The middleware 132 may serve as an intermediary such that the API 133 or the application 134 communicates with the kernel 131 to transmit/receive data. Further, in relation to requests for operation received from the applications 134, the middleware 132 may control (for example, scheduling or load-balancing) the operation requests by using, for example, a method of determining sequence for using system resources (for example, the bus 110, the processor 120, the memory 130 and the like) of the electronic device 101 with respect to at least one application among the applications 134.

The API 133 is an interface by which the applications 134 control a function provided from the kernel 131 or the middleware 132, and may include, for example, at least one interface or function (for example, instructions) for file control, window control, image processing, or text control.

According to various embodiments, the applications 134 may include at least one of a Short Message Service (SMS)/Multimedia Messaging Service (MSS) application, an email application, a calendar application, an alarm application, a health care application (for example, application for measuring at least one of exercise amounts and blood sugar), an environmental information application (for example, application providing information on at least one of air pressure, humidity, temperature and the like). Additionally or alternatively, the applications 134 may be an application related to the exchange of information between the electronic device 101 and external electronic devices (for example, an electronic device 104). The application related to the exchange of information may include, for example, a notification relay application for transferring predetermined information to the external electronic device or a device management application for managing the external electronic device.

For example, the notification relay application may include a function of transferring notification information generated in other applications (for example, the SMS/MMS application, the e-mail application, the health care application, or the environmental information application) of the electronic device 101 to external electronic devices (for example, the electronic device 104). Additionally or alternately, the notification relay application may, for example, receive notification information from an external electronic device (for example, the electronic device 104), and may provide the received notification information to a user. The device management application may manage (for example, at least one of installation, deletion, or updating), for example, at least some functions (for example, turning external electronic device (or some elements) on or off, or adjusting the brightness (or resolution) of a display) of an external electronic device (for example, the electronic device 104) that communicates with the electronic device 101, applications performed in the external electronic device, or services (for example, a call service or a message service) provided in the external electronic device.

According to various embodiments, the applications 134 may include applications, which are designated according to the property (for example, the type of electronic device) of the external electronic device (for example, the electronic device 104). For example, when the external electronic device is an MP3 player, the applications 134 may include an application related to the reproduction of music. Similarly, in cases where an external electronic device is a mobile medical appliance, the applications 134 may include an application relating to health care. According to an embodiment, the applications 134 may include at least one of an application designated to the electronic device 101 and an application received from the external electronic device (for example, a server 106 or the electronic device 104).

The input/output interface 140 may transmit an instruction or data input by the user through an input/output device (for example, at least one of a sensor, a keyboard, and a touch screen) to at least one of the processor 120, the memory 130, the communication interface 160, and the communication control module 170 through, for example, the bus 110. For example, the input/output interface 140 may provide, to the processor 120, data for a user's touch which is input through the touch screen. The input/output interface 140 may output an instruction or data received from at least one of the bus 110, from the processor 120, the memory 130, the communication interface 160, and the communication control module 170 through the input/output device (for example, at least one of a speaker and a display). For example, the input/output interface 140 may output voice data processed by the processor 120 to the user through the speaker.

The display 150 may display various pieces of information (for example, at least one of multimedia data and text data) for the user.

The communication interface 160 may make a communication connection between the electronic device 101 and external electronic devices (for example, the electronic device 104 or the server 106). For example, the communication interface 160 may be connected to a network 262 through wireless or wired communication to communicate with the external device. The wireless communication may include at least one of Wi-Fi, Wi-Fi Direct, Bluetooth (BT), Near Field Communication (NFC), a Global Positioning System (GPS), or cellular communication (for example, LTE, LTE-A, CDMA, WCDMA, UMTS, WiBro, or GSM). The wired communication may include at least one of, for example, a Universal Serial Bus (USB), a High Definition Multimedia Interface (HDMI), Recommended Standard 232 (RS-232), and a Plain Old Telephone Service (POTS).

According to an embodiment, the network 162 may be a telecommunication network. The telecommunication network may include at least one of a computer network, the Internet, the Internet of Things, and a telephone network. According to an embodiment, a protocol (for example, a transport layer protocol, a data link layer protocol, or a physical layer protocol) for communication between the electronic device 101 and external electronic devices may be supported by at least one of the applications 134, the API 133, the middleware 132, the kernel 131, and the communication interface 160.

According to an embodiment, the communication control module 170 may support driving of the electronic device 101 by performing at least one of the operations (or functions) implemented in the electronic device 101. For example, the server 106 may include a communication control server module 108 capable of supporting the application operation module 170 implemented in the electronic device 101. For example, the communication control server module 108 may include at least one component of the communication control module 170, and may perform (for example, perform as a proxy) at least one of the operations performed by the communication control module 170.

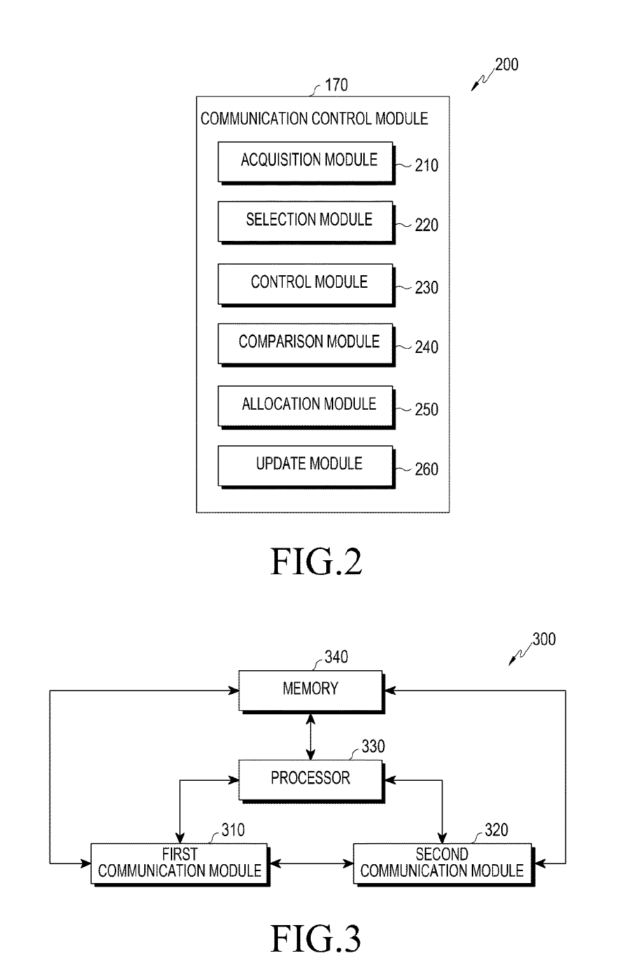

The communication control module 170 may process at least some of the information obtained from other components (for example, at least one of the processor 120, the memory 130, the input/output interface 140, and the communication interface 160) and utilize the same in various manners. For example, the communication control module 170 may control at least some functions of the electronic device 101 by using the processor 120 or independently from the processor 120 so that the electronic device 101 may interwork with other electronic devices (for example, the electronic device 104 or the server 106). The communication control module 170 may be integrated into the processor 120 or the communication interface 160. According to an embodiment, at least one element of the communication control module 170 may be included in the server 106 (for example, the communication control server module 108) and receive at least one operation, which is performed by the communication control module 170, from the server 106. Additional information on the communication control module 170 is provided through FIG. 2 described below.

FIG. 2 is a block diagram 200 of the communication control module 170 of the electronic device (for example, the electronic device 101) according to various embodiments of the present invention. Referring to FIG. 2, the communication control module 170 may include an acquisition module 210, a selection module 220, a control module 230, a comparison module 240, an allocation module 250, and an update module 260. The communication control module 170 may be provided separately from a processor (for example, the processor 120) and at least one communication module, or the whole communication control module 170 may be integrated into one of the processor and the at least one communication module or parts thereof may be integrated into the processor and the at least one communication module, respectively.

The acquisition module 210 according to various embodiments of the present invention may acquire first setting information on a first communication operation of a first communication module (for example, a cellular module, an LTE module, a Communication Processor (CP), or the like) arranged within the electronic device. The acquisition module 210 may acquire second setting information on a second communication operation of a second communication module (for example, a Wi-Fi module, a Bluetooth module, or the like) arranged within the electronic device.

The first communication operation may be at least one of Internet communication, WebRTC communication, IP Multimedia Subsystem or IP Multimedia Core Network Subsystem (IMS) communication, a voice call, a video call, a video chatting, IMS-based Short Message Service (SMS) communication, a telephone conference, Instant Message (IM) communication, a group chatting, file transmission communication, image/video sharing communication, and the like between the electronic device and a mobile communication network (for example, a phone network or the like) or a counterpart device (for example, a first server, a second electronic device, or the like) through the mobile communication network. The first communication operation may be performed through the first communication module. The first communication operation may be performed based on information on a subscriber registered in the mobile communication network. The subscriber information may include at least one of a subscriber phone number, a subscriber identification number, an International Mobile Station Identity (IMSI), and the like. The subscriber information may be stored in a subscriber identification module of the electronic device. A communication scheme of the first communication operation may be cellular communication (for example, LTE, LTE-A, CDMA, WCDMA, UMTS, WiBro, Global System for Mobile Communications (GSM), and the like).

The second communication operation may be at least one of Internet communication, WebRTC communication, a voice call, a video call, a video chatting, a telephone conference, Instant Message (IM) communication, a group chatting, file transmission communication, image/video sharing communication, and the like between the electronic device and a counterpart device (for example, a second server, a second electronic device, or the like) connected to the electronic device directly or through a data communication network (for example, Internet or the like). The second communication operation may be performed through the second communication module. A communication scheme of the second communication operation may be non-cellular communication such as Wi-Fi (wireless fidelity), Wi-Fi direct, Bluetooth (BT), Near Field Communication (NFC), a Global Positioning System (GPS), and the like.

The first setting information may include communication frequency information (for example, transmission frequency information or reception frequency information), communication signal strength information (for example, transmitted signal strength information or received signal strength information), and/or communication capability information (for example, transmission capability information or reception capability information). The communication frequency information of the first setting information may include a communication channel (for example, a transmission channel or a reception channel), a communication frequency (for example, a transmission frequency or a reception frequency), a communication frequency band (for example, a transmission frequency band or a reception frequency band), a communication frequency bandwidth (for example, a transmission frequency bandwidth or a reception frequency bandwidth), and the like. The communication signal strength information of the first setting information may include a communication signal strength (for example, a transmitted signal strength or a received signal strength). The communication capability information of the first setting information may include an interference degree or level according to the transmitted signal strength, a transmitted signal strength according to an allowed interference level, a filtering capability of a transmitted signal, a reception capability according to a received signal strength and an interference signal level, an interference level range allowed to acquire a particular reception capability, and the like. Selectively, the communication capability information of the first setting information may include a transmitted signal strength control range, a filtering capability of a received signal, an allowed range of a received signal strength, an allowed range of a Signal-to-Noise Ratio (SNR) according to a received signal strength, reception capability change information (for example, SNR increase information or the like) according to an interference level for indicating a degree of interference which a transmitted signal gives to a received signal, allowable interference level information, an allowable reception capability change, and the like.

The second setting information may include communication frequency information (for example, transmission frequency information or reception frequency information), communication signal strength information (for example, transmitted signal strength information or received signal strength information), and/or communication capability information (for example, transmission capability information or reception capability information). The communication frequency information of the second setting information may include a communication channel (for example, a transmission channel or a reception channel), a communication frequency (for example, a transmission frequency or a reception frequency), a communication frequency band (for example, a transmission frequency band or a reception frequency band), a communication frequency bandwidth (for example, a transmission frequency bandwidth or a reception frequency bandwidth), and the like. The communication signal strength information of the second setting information may include a communication signal strength (for example, a transmitted signal strength or a received signal strength). The communication capability information of the second setting information may include a transmitted signal strength control range, a filtering capability of a received signal, an allowed range of a received signal strength, an allowed range of a Signal-to-Noise Ratio (SNR) according to a received signal strength, reception capability change information (for example, SNR increase information or the like) according to an interference level for indicating a degree of interference which a transmitted signal gives to a received signal, allowable interference level information, an allowable reception capability change, and the like. Selectively, the communication capability information of the second setting information may include an interference degree or level according to the transmitted signal strength, a transmitted signal strength according to an allowed interference level, a filtering capability of a transmitted signal, a reception capability according to a received signal strength and an interference signal level, an interference level range allowed to acquire a particular reception capability, and the like.

The selection module 220 according to various embodiments of the present invention may select one piece of a plurality of predetermined control information for controlling the second communication operation based on at least one piece of the first setting information and the second setting information.

The selection module 220 may select one piece of the plurality of control information based on at least one piece of communication frequency information of the first setting information, communication signal strength information of the first setting information, communication capability information of the first setting information, communication frequency information of the second setting information, communication signal strength information of the second setting information, and communication capability information of the second setting information.

The plurality of control information may be a plurality of predetermined interference levels for indicating a degree of interference which a transmitted signal gives to a received signal, a plurality of control commands or control values related to transmission or reception of a signal, or a plurality of limited or allowed conditions related to transmission or reception of a signal.

The control module 230 according to various embodiments of the present invention may limit the second communication operation based on the selected control information. Limiting the second communication operation may be initiating signal transmission, stopping signal transmission, delaying signal transmission, controlling a transmitted signal strength, initiating signal reception, stopping signal reception, delaying signal reception, or controlling a received signal strength.

According to an embodiment, the selection module 220 may select one of a plurality of pieces of predetermined control information for controlling the first communication operation based on at least one piece of the first setting information and the second setting information. The control module 230 may control the first communication operation based on the selected control information. Limiting the first communication operation may be initiating signal transmission, stopping signal transmission, delaying signal transmission, controlling a transmitted signal strength, initiating signal reception, stopping signal reception, delaying signal reception, or controlling a received signal strength.

According to an embodiment, the control module 230 may transmit an interference level selected from the plurality of interference levels, a control command or a control value selected from the plurality of control commands or control values, or a limited condition or an allowed condition selected from the plurality of limited conditions or allowed conditions to the second communication module.

According to an embodiment, the selection module 220 may select one piece of a plurality of predetermined interference levels for indicating a degree of interference which a transmitted signal gives to a received signal based on at least one piece of communication frequency information of the first setting information, communication signal strength information of the first setting information, communication capability information of the first setting information, communication frequency information of the second setting information, communication signal strength information of the second setting information, and communication capability information of the second setting information. The control module 230 may limit the second communication operation of the second communication module based on the selected interference level.

The comparison module 240 according to various embodiments of the present invention may compare the communication frequency information of the first setting information and the communication frequency information of the second setting information. According to an embodiment, the comparison module 240 may compare at least one piece of the communication frequency information of the first setting information and the communication frequency information of the second setting information with at least one predetermined range or at least one value. The selection module 220 may initiate an operation for selecting one piece of the plurality of control information based on a result of the comparison operation.

According to an embodiment, the comparison module 240 may determine a difference between the communication frequency of the first setting information and the communication frequency of the second setting information and compare the difference with a predetermined threshold value. The selection module 220 may select one piece of the plurality of control information when the difference is equal to or smaller than the predetermined threshold value.

According to an embodiment, the comparison module 240 may compare the communication frequency information of the first setting information and the communication frequency information of the second setting information with each other or with predetermined ranges or values, and compare the communication signal strength information of the first setting information and the communication signal strength information of the second setting information with each other or with predetermined ranges or values. The selection module 220 may select one piece of the plurality of control information based on a result of the comparison operations.

According to an embodiment, the selection module 220 may select one of a plurality of predetermined interference levels for indicating a degree of interference which a transmitted signal gives a received signal based on at least one piece of the reception frequency information, the received signals strength information, the transmission frequency information, and the transmitted signal strength information included in the first and second setting information. The comparison module 240 may compare the received signal strength information with at least one predetermined range or at least one value related to the selected interference level. The control module 230 may limit the second communication operation based on a result of the comparison operation.

According to an embodiment, the selection module 220 may select one of a plurality of predetermined interference levels for indicating a degree of interference which a transmitted signal gives a received signal based on at least one piece of the reception frequency information, the received signals strength information, the transmission frequency information, and the transmitted signal strength information included in the first and second setting information. The comparison module 240 may compare the received signal strength information with at least one predetermined range or at least one value related to the selected interference level. The control module 230 may limit the second communication operation based on the result of the comparison operation and reception capability information predetermined in connection with the received signals strength information and the selected interference level.

According to an embodiment, the selection module 220 may select one of a plurality of predetermined interference levels for indicating a degree of interference which a transmitted signal gives a received signal based on at least one piece of the reception frequency information, the received signals strength information, the transmission frequency information, and the transmitted signal strength information included in the first and second setting information. The comparison module 240 may determine a reception capability of the second communication operation based on predetermined reception capability information related to the received signals strength information and the selected interference level. The comparison module 240 may compare the reception capability with at least one predetermined range or at least one value. The control module 230 may control a signal reception operation of the second communication module based on a result of the comparison operation.

According to an embodiment, the selection module 220 may select an interference level corresponding to a maximum interference degree or intensity allowed in the first communication operation among a plurality of predetermined interference levels for indicating a degree of interference which a transmitted signal gives a received signal. The control module 230 may control a signal transmission operation of the second communication module based on a range of a transmitted signal strength allowed for the selected interference level.

The allocation module 250 according to various embodiments of the present invention may allocate a priority to each of the first communication module and the second communication module. The allocation module 250 may allocate a higher priority to the first communication module than the second communication module. According to an embodiment, the allocation module 250 may allocate a relatively higher priority to a cellular module of the electronic device and allocate a relatively lower priority to a Wi-Fi module or a Bluetooth module of the electronic device. According to an embodiment, the allocation module 250 may allocate a relatively higher priority to a communication module of the electronic device using a paid network and allocate a relatively lower priority to another communication module of the electronic device using a free network or a paid network that is cheaper than the paid network. According to an embodiment, the allocation module 250 may allocate a relatively higher priority to a communication module of the electronic device that provides a service having relatively high importance, relatively high urgency, and continuity (for example, a call, a meeting, file reception, emergency call, a streaming service, periodic service, and the like) and allocate a relatively lower priority to another communication module of the electronic device that provides a service having relatively low importance, relatively low urgency, and non-continuity (for example, a message, file transmission, a general call, an Internet service, an aperiodic service, and the like). According to an embodiment, the allocation module 250 may acquire priority information of a first application (or a first service) using the first communication module and priority information of an application (or a second service) using the second communication module, and allocate priorities to the first and second communication modules according to the priority information. The allocation module 250 may allocate priorities according to each type of application and each type of service.

For example, the first communication module (for example, a cellular module, an LTE module, or the like) may have a higher priority than that of the second communication module (for example, a Wi-Fi module, a Bluetooth module, or the like). For example, when free Wi-Fi can be used, a data service may mostly use Wi-Fi communication instead of cellular communication, but main services such as an MMS, VoLTE, and the like may be serviced through the cellular communication.

In a database including a plurality of predetermined interference levels and a plurality of pieces of reception capability information related to the plurality of interference levels, the update module 260 according to various embodiments of the present invention may update corresponding reception capability information of the database based on a measurement result of the actual reception capability.

FIG. 3 illustrates a communication control system according to various embodiments of the present invention. A communication control system 300 may include a first communication module 310, a second communication module 320, a processor 330, and a memory 340. The first communication module 310 (for example, a cellular module, an LTE module, or the like) may perform a first communication operation with a mobile communication network (or a phone network) or a counterpart device (for example, a first server, a second electronic device, or the like) through the mobile communication network. The second communication module 320 (for example, a Wi-Fi module, a Bluetooth module, or the like) may perform a second communication operation with a counterpart device (for example, a second server, a second electronic device, or the like) directly connected thereto or through a data communication network (for example, Internet or the like).

The processor 330 may include one process or a plurality of processors, and may be provided separately from the first and second communication modules 310 and 320, or may be integrated with one of the first and second communication modules 310 and 320 or the first and second communication modules 310 and 320 and two processors may be integrated, respectively. Alternatively, one of the first and second communication modules 310 and 320 may be integrated with the first processor, and the second processor may be provided separately from the first and second communication modules 310 and 320. For example, the processor 330 may include a Communication Processors (CP) and/or an Application Processor (AP).

The memory 340 may include one memory or a plurality of memories, and may be provided separately from the first communication module 310 and the second communication module 320, may be included in one of the processor 330, the first communication module 310, and the second communication module 320, or three memories may be evenly distributed among the processor 330, the first communication module 310, and the second communication module 320. Alternatively, a first memory may be included in one of the processor 330, the first communication module 310, and the second communication module 320, and a second memory may be provided separately from the processor 330, the first communication module 310, and the second communication module 320.

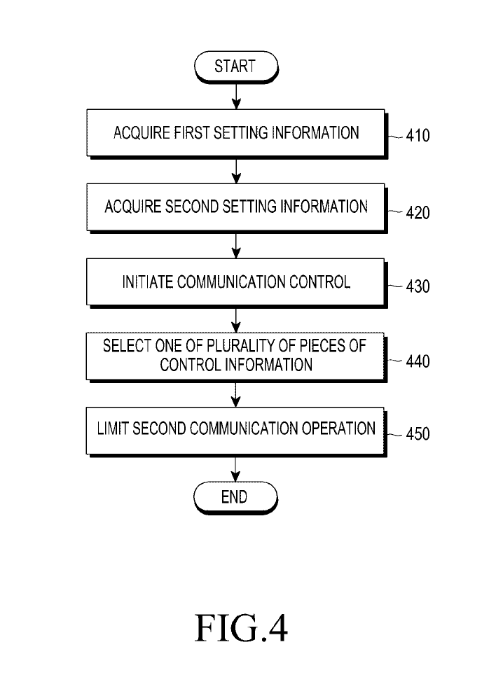

FIG. 4 illustrates a communication control method of a communication control system according to various embodiments of the present invention.

In operation 410, first setting information on a first communication operation of a first communication module may be acquired by one of the first communication module (for example, the first communication module 310), a second communication module (for example, the second communication module 320), and a processor (for example, the processor 330). The first setting information may be stored in one of the processor, the first communication module, and a memory (for example, the memory 340). According to an embodiment, the processor may receive the first setting information from the first communication module or the memory. According to an embodiment, the first communication module may read the first setting information from the memory.

In operation 420, second setting information on a second communication operation of a second communication module may be acquired by one of the first communication module, the second communication module, and the processor. The second setting information may be stored in one of the processor, the second communication module, and the memory. According to an embodiment, the processor may receive the second setting information from the first communication module, the second communication module, or the memory. According to an embodiment, the first communication module may receive the second setting information from the second communication module or the memory.

In operation 430, a communication control (that is, limit of the second communication operation) of the second communication module may be initiated by one of the processor, the first communication module and the second communication module.

One of the processor, the first communication module, and the second communication module may initiate the communication control of the second communication module based on first communication frequency information (for example, a communication frequency, a communication frequency band, a communication channel, and the like) of the first setting information and second communication frequency information (for example, a communication frequency, a communication frequency band, a communication channel, and the like) of the second setting information.

According to an embodiment, one of the processor, the first communication module, and the second communication module may determine whether the first communication frequency, the first communication frequency band, or the first communication channel of the first setting information is within a predetermined first frequency range (for example, 2300 to 2400 MHz) or matches a predetermined first value (for example, a channel number, a Resource Block (RB) number, or the like). One of the processor, the first communication module, and the second communication module may determine whether the second communication frequency, the second communication frequency band, or the second communication channel of the second setting information is within a predetermined second frequency range (for example, 2400 to 2500 MHz) or matches a predetermined second value (for example, a channel number). When the first communication frequency, the first communication frequency band, or the first communication channel is within the predetermined first frequency range or matches the predetermined first value and the second communication frequency, the second communication frequency band, or the second communication channel is within the predetermined second frequency range or matches the predetermined second value, one of the processor, the first communication module, and the second communication module may initiate the communication control of the second communication module.

According to an embodiment, one of the processor, the first communication module, and the second communication module may determine a difference between the first communication frequency, the first communication frequency band, or the first communication channel of the first setting information and the second communication frequency, the second communication frequency band, or the second communication channel of the second setting information. One of the processor, the first communication module, and the second communication module may compare the difference with a predetermined threshold value (for example, 30 MHz). When the difference is equal to or smaller than the predetermined threshold value, one of the processor, the first communication module, and the second communication module may initiate the communication control of the second communication module.

The initiation of the communication control may include at least one of transmission of an initiation command, transmission of control information, and reception of control information.

According to an embodiment, one of the processor, the first communication module, and the second communication module may transmit a communication control initiation command to each of the first communication module and the second communication module. According to an embodiment, the processor may transmit the communication control initiation command to the second communication module through the first communication module. According to an embodiment, the first communication module may transmit the communication control initiation command to the second communication module directly or through the processor.

In operation 440, one of the processor, the first communication module, and the second communication module may select one of a plurality of pieces of predetermined control information for controlling the second communication operation. One of the processor, the first communication module, and the second communication module may transmit the selected control information to the second communication module. According to an embodiment, the processor may transmit the selected control information to the second communication module through the first communication module. According to an embodiment, the first communication module may transmit the selected control information to the second communication module directly or through the processor.

According to an embodiment, one of the processor, the first communication module, and the second communication module may select one of a plurality of pieces of predetermined control information based on a pre-stored first control information database. The first control information database may be stored in one of the processor, the first communication module, the second communication module, and the memory.

According to an embodiment, the first control information database may have the form illustrated in Table 1.

TABLE 1

| | Transmitted signal | Control |
|---|---|---|
| Frequency difference | strength | information |
| A1 | B1 | C1 |
| A1 | B2 | C2 |
| A2 | B1 | C3 |
| A2 | B2 | C4 |
| . . . | . . . | . . . |

In Table 1, the frequency difference (for example, A1, A2, . . . ) may indicate a difference between a transmission frequency (or a transmission frequency band) and a reception frequency (or a reception frequency band), and A1 and A2 may indicate frequency ranges (for example, 0 to 10 MHz, 10 to 20 MHz, and the like). In Table 1, the transmitted signal strength (for example, B1, B2, . . . ) may indicate a transmitted signal strength range (for example, a dB value, or the like) of the first communication module, and the control information (for example, C1, C2, . . . ) may indicate a command, a numerical value, a condition, and or the like.

According to an embodiment, a frequency difference item may be replaced with a transmission frequency item that defines predetermined frequency ranges and/or a reception frequency item that defines predetermined frequency ranges.

The plurality of control information may be a plurality of predetermined interference levels for indicating a degree of interference which a transmitted signal gives to a received signal, a plurality of control commands or control values related to reception of a signal, or a plurality of limited conditions or allowed conditions related to reception of a signal. Limiting the second communication operation may be initiating a receive signal, stopping a received signal, delaying signal reception, or controlling a received signal strength.

According to an embodiment, one of the processor, the first communication module, and the second communication module may calculate a difference between the transmission frequency of the first communication module and the reception frequency of the second communication module, identify a predetermined frequency range to which the frequency difference belongs among predetermined frequency ranges of the first control information database, identify a transmitted signal strength range to which the transmitted signal strength belongs among predetermined transmitted signal strength ranges of the first control information database, and select control information corresponding to the identified frequency range and the identified transmitted signal strength range.

According to an embodiment, one of the processor, the first communication module, and the second communication module may select one of a plurality of predetermined interference levels for indicating a degree of interference which a transmitted signal gives a received signal based on at least one piece of the first and second setting information.

According to an embodiment, one of the processor, the first communication module, and the second communication module may select one of a plurality of predetermined interference levels based on a pre-stored second control information database. The second control information database may be stored in one of the processor, the first communication module, the second communication module, and the memory.

According to an embodiment, the second control information database may have the form illustrated in Table 2.

TABLE 2

| Frequency | Transmitted | |
|---|---|---|
| difference | signal strength | Interference level |
| A1 | B1 | D1 |
| A1 | B2 | D2 |
| A2 | B1 | D3 |
| A2 | B2 | D4 |
| . . . | . . . | . . . |

In Table 2, the frequency difference (for example, A1, A2, . . . ) may indicate a difference between a transmission frequency (or a transmission frequency band) and a reception frequency (or a reception frequency band), and A1 and A2 may indicate frequency ranges (for example, 0 to 10 MHz, 10 to 20 MHz, and the like). In Table 1, the transmitted signal strength (for example, B1, B2, . . . ) may indicate a transmitted signal strength range (for example, a dB value or the like) of the first communication module, and the interference level (for example, D1, D2, . . . ) may indicate a numerical value (for example, an ordinal number (for example, 1, 2, 3, . . . , or the like)). According to an embodiment, a frequency difference item may be replaced with a transmission frequency item that defines predetermined frequency ranges and/or a reception frequency item that defines predetermined frequency ranges.

For example, the first and/or the second communication module may directly measure or predict a degree of interference which a transmitted signal gives to a received signal, measure or predict a state of a received signal (a received signal strength, a transmitted signal strength, or the like) which can be normally or restrictively received according to the interference degree or strength, and simultaneously perform a communication operation according to results of the measurement and the prediction.

For example, the first communication module uses 2370 to 2390 MHz but actually uses 2370 to 2380 MHz, and, when a transmitted signal strength is 0 dB, an influence of interference on a first channel of the second communication module may not be large. As the transmitted signal strength is weaker, an influence on an adjacent frequency band may be smaller. In this case, the second communication module can receive the signal restrictively or normally (or totally).

For example, with respect to the first and/or the second communication module, the interference degree or strength according to each communication condition may be measured and leveled, and then an interference influence of each interference level may be stored. For example, a degree or strength of interference that the transmission signal of the first communication module using a B40 frequency band gives to the second communication module using an ISM frequency band may be measured according to a difference between the frequencies used by the first communication module and the second communication module, and a reception capability of the ISM frequency band may be measured according to each interference level. Similarly, a reception capability of the B40 frequency band may be measured according to each interference level that the transmitted signal of the ISM frequency band gives to the received signal of the B40 frequency band.

According to an embodiment, one of the processor, the first communication module, and the second communication module may calculate a difference between the transmission frequency of the first communication module and the reception frequency of the second communication module, identify a predetermined frequency range to which the frequency difference belongs among predetermined frequency ranges of the second control information database, identify a transmitted signal strength range to which the transmitted signal strength belongs among predetermined transmitted signal strength ranges of the second control information database, and select interference level corresponding to the identified frequency range and the identified transmitted signal strength range.

According to an embodiment, one of the processor, the first communication module, and the second communication module may select an interference level in consideration of an allocated frequency (or frequency band), a transmitted signal strength, an actually used frequency (or frequency band) among allocated frequencies (or frequency bands), a reception filter capability, an antenna capability, and the like.

For example, in the B40 frequency band (that is, 2300 to 2400 MHz) used in LTE, a frequency band that gives a large influence to an Industrial, Scientific and Medical (ISM) frequency band used in Wi-Fi or Bluetooth is 20 to 30 MHz, and an interference degree or strength may be larger as the LTE frequency band is closer to the ISM frequency band. For example, when 2380 to 2400 MHz is used in LTE, an interference degree or strength provided to the ISM frequency band may be larger than a case where 2370 to 2390 MHz is used. For example, in the ISM frequency band, a first channel (2401 to 2423 MHz), a second channel (2406 to 2428 MHz), a third channel (2411 to 2433 MHz), and a fourth channel (2416 to 2438 MHz) may be allocated as Wi-Fi channels.

For example, as a transmitted signal strength of LTE is stronger, an interference strength or degree provided to the ISM frequency band may be stronger.

For example, even though LTE uses the same frequency 2380 to 2400 MHz, a strength of interference in the ISM frequency band may be stronger in a case where an actually used frequency is high, that is, a base station allocates a Radio Bearer (RB) of a high frequency to the electronic device within the range of 20 MHz than a case of a low frequency.

For example, even though LTE uses 2360 to 2380 MHz, there may be little interference if an actually allocated and used frequency is low, for example, 2360 to 2370 MHz.

For example, even though LTE uses the same frequency 2380 to 2400 MHz and uses the same transmission power, a strength of interference in the ISM frequency band may be stronger in a case where an actually allocated frequency range is wide, that is, a base station allocates a Radio Bearer (RB) to the electronic device over a wider frequency range within the range of 20 MHz than a case where an allocated frequency is narrow.

According to an embodiment, one of the processor, the first communication module, and the second communication module may select one of a plurality of pieces of predetermined control information based on a pre-stored third control information database. The third control information database may be stored in one of the processor, the first communication module, the second communication module, and the memory.

According to an embodiment, the third control information database may have the form illustrated in Table 3.

TABLE 3

| Frequency | Received | Reception | Control |
|---|---|---|---|
| difference | signal strength | capability | information |
| A1 | E1 | F1 | G1 |
| A1 | E1 | F2 | G2 |
| A1 | E2 | F1 | G3 |
| A1 | E2 | F2 | G4 |
| A2 | E1 | F1 | G5 |
| A2 | E1 | F2 | G6 |
| . . . | . . . | . . . | . . . |

In Table 3, the frequency difference (for example, A1, A2, . . . ) may indicate a difference between a transmission frequency (or a transmission frequency band) and a reception frequency (or a reception frequency band), and A1 and A2 may indicate frequency ranges (for example, 0 to 10 MHz, 10 to 20 MHz, and the like). In Table 3, the received signal intensity (for example, E1, E2, . . . ) may indicate a received signal strength range (for example, a dB value or the like) of the first communication module, the reception capability (for example, F1, F2, . . . ) may indicate a range of a Signal-to-Noise Ratio (SNR) or a data reception error rate of the first communication module, and the control information (for example, G1, G2, . . . ) may indicate a command, a numerical value, a condition, or the like. The reception capability may indicate a signal reception environment or state in consideration of or with no regard to degradation of the reception capability due to interference. According to an embodiment, a frequency difference item may be replaced with a transmission frequency item that defines predetermined frequency ranges and/or a reception frequency item that defines predetermined frequency ranges.

The plurality of control information may be a plurality of predetermined interference levels for indicating a degree of interference which a transmitted signal gives to a received signal, a plurality of control commands or control values related to transmission of a signal, or a plurality of limited conditions or allowed conditions related to transmission or of a signal. Limiting the second communication operation may include initiating signal transmission, stopping signal transmission, delaying signal transmission, and controlling a transmitted signal strength.

According to an embodiment, one of the processor, the first communication module, and the second communication module may calculate a difference between the reception frequency of the first communication module and the transmission frequency of the second communication module, identify a predetermined frequency range to which the frequency difference belongs among predetermined frequency ranges of the third control information database, identify a received signal strength range to which an actual received signal strength belongs among predetermined received signal strengths of the third control information database, identify a reception capability range to which an actual reception capability belongs among predetermined reception capability ranges of the third control information database, and select control information corresponding to the identified frequency range, the identified received signal strength range, and the identified reception capability range.

According to an embodiment, one of the processor, the first communication module, and the second communication module may select one of a plurality of predetermined interference levels based on a pre-stored fourth control information database. The fourth control information database may be stored in one of the processor, the first communication module, the second communication module, and the memory.

According to an embodiment, the fourth control information database may have the form illustrated in Table 4.

TABLE 4

| Frequency | Received signal | Reception | |
|---|---|---|---|
| difference | strength | capability | Interference level |
| A1 | E1 | F1 | D1 |
| A1 | E1 | F2 | D2 |
| A1 | E2 | F1 | D3 |
| A1 | E2 | F2 | D4 |
| A2 | E1 | F1 | D5 |
| A2 | E1 | F2 | D6 |
| . . . | . . . | . . . | . . . |

In Table 4, the frequency difference (for example, A1, A2, . . . ) may indicate a difference between a transmission frequency (or a transmission frequency band) and a reception frequency (or a reception frequency band), and A1 and A2 may indicate frequency ranges (for example, 0 to 10 MHz, 10 to 20 MHz, and the like). In Table 4, the received signal intensity (for example, E1, E1, . . . ) may indicate a received signal strength range (for example, a dB value or the like) of the first communication module, the reception capability (for example, F1, F2, . . . ) may indicate a range of a Signal-to-Noise Ratio (SNR), a data reception error rate, and a data reception speed of the first communication module, and the interference level (for example, D1, D2, . . . ) may indicate a numerical value (for example, an ordinal number (for example, 1, 2, 3, . . . ). The reception capability may indicate a signal reception environment or state in consideration of or with no regard to degradation of the reception capability due to interference.

For example, when a degree of interference that the first communication module transmitting a signal gives to a received signal of the second communication module is small and a received signal strength of the second communication module is weak, the second communication module may have an allowable SNR and, in this case, the first and second communication modules may perform normal communication.

According to an embodiment, one of the processor, the first communication module, and the second communication module may calculate a difference between the reception frequency of the first communication module and the transmission frequency of the second communication module, identify a predetermined frequency range to which the frequency difference belongs among predetermined frequency ranges of the fourth control information database, identify a received signal strength range to which an actual received signal strength belongs among predetermined received signal strength ranges of the fourth control information database, identify a reception capability range to which an actual reception capability belongs among predetermined reception capability ranges of the fourth control information database, and select an interference level corresponding to the identified frequency range, the identified received signal strength range, and the identified reception capability range.

In operation 450, the second communication module may limit the second communication operation based on the selected control information.

The second communication module may initiate signal reception, stop signal reception, delay signal reception, or control a received signal strength according to the selected control information.

According to an embodiment, the second communication module may perform a limited operation corresponding to the interference level of the selected control information based on a pre-stored fifth control information database. The fifth control information database may be stored in one of the processor, the first communication module, the second communication module, and the memory.

According to an embodiment, the second communication module may compare received signal strength information with at least one range or at least one value predetermined in connection with the interference level and limit the second communication operation based on a result of the comparison operation, and reception capability information predetermined in connection with the received signal strength information and the interference level.

According to an embodiment, the fifth control information database may have the form illustrated in Table 5.

TABLE 5

| | Received | | |
|---|---|---|---|
| | signal | Reception | |
| Interference level | strength | capability | Limit information |
| D1 | H1 | I1 | J1 |
| D1 | H1 | I2 | J2 |
| D1 | H2 | I1 | J3 |
| D1 | H2 | I2 | J4 |
| D2 | H1 | I1 | J5 |
| D2 | H1 | I2 | J6 |
| . . . | . . . | . . . | . . . |

In Table 5, the interference level (for example, D1, D2, . . . ) may indicate a numerical value (for example, an ordinal number (for example, 1, 2, 3, . . . ), the received signal strength (for example, H1, H2, . . . ) may indicate a received signal strength range (for example, a dB value or the like) of the second communication module, the reception capability (for example, I1, I2, . . . ) may indicate a Signal-to-Noise Ratio (SNR) or a data reception error rate of the second communication module, and the limit information (for example, J1, J2, . . . ) may indicate a command, a numerical value, a condition, or the like. The reception capability may indicate a signal reception environment or state in consideration of or with no regard to degradation of the reception capability due to interference. The limit information may be initiation of signal reception, stoppage of signal reception, delaying of signal reception, or controlling of received signal strength.

According to an embodiment, the second communication module may identify a received signal strength range to which an actual received signal strength belongs among received signal strength ranges of the fifth control information database, identify a reception capability range to which an actual reception capability belongs among predetermined reception capability ranges of the fifth control information database, and select limit information corresponding to the received interference level, the identified received signal strength range, and the identified reception capability range.

For example, the reception capability of the second communication module may vary depending on the received signal strength of the second communication module. When the interference level is very low and the received signal strength is higher than or equal to a predetermined threshold value, the second communication module can normally receive the signal. The second communication module may measure or calculate the received signal strength, which can be normally received, for each interference level. The second communication module may measure or calculate a degree of a capability reduction according to the received signal strength for each interference level. The reception capability information may be measured, calculated, or predicted in advance and stored, and the second communication module may limit the communication operation of the second communication module based on the stored reception capability information when the communication control is initiated. The reception capability of the second communication module may be changed according to the time, so that the second communication module may periodically measure a communication state or condition, and an interference degree, strength, and influence to update the corresponding information. The second communication module may measure the reception capability information when the communication control is initiated and update the corresponding information periodically or according to a condition without storing the reception capability information in advance.

For example, the interference level between the first communication module (for example, the LTE module) and the second communication module (for example, the Wi-Fi module) may be divided into a plurality of interference levels, and information on a degree of a reduction in the reception capability according to the received signal strength for each interference level may be shared between the first and second communication modules. The first communication module may calculate the interference level in consideration of various conditions such as frequency band information allocated before the signal is transmitted, actually used frequency band information, the transmitted signal strength, and the like, and transmit the calculated interference level to the second communication module. The second communication module may determine whether to receive the signal in consideration of the received interference level, a currently received signal state, capability, condition, and the like. The second communication module may determine a reference of the reception capability according to a situation and receive the signal when the corresponding reference is met. The reference of the reception capability may vary depending on the situation.

According to an embodiment, the second communication module may limit the second communication operation according to limit information corresponding to the received interference level in a sixth control information database. The sixth control information database may be stored in one of the processor, the first communication module, the second communication module, and the memory.

According to an embodiment, the sixth control information database may have the form illustrated in Table 6.

TABLE 6

| | Limit |
|---|---|
| Interference level | information |
| D1 | K1 |
| D2 | K2 |
| D3 | K3 |
| D4 | K4 |
| D5 | K5 |
| D6 | K6 |
| . . . | . . . |

In Table 6, the interference level (for example, D1, D2, . . . ) may indicate a numerical value (for example, an ordinal number (for example, 1, 2, 3, . . . ), and the limit information (for example, K1, K2, . . . ) may indicate a command, a numerical value, a condition, or the like. The limit information may be initiation of signal transmission, stoppage of signal transmission, delaying of signal transmission, or controlling of a transmitted signal strength.

For example, the first communication module may determine an interference level which does not generate degradation of the reception capability of the first communication module in consideration of a state of a received signal, capability, condition, or the like before receiving the signal, and transmit the determined interference level to the second communication module. The second communication module may transmit the signal within a range in which interference higher than or equal to the received interference level is not generated. The second communication module may determine various transmission factors, parameters, and the like to meet the corresponding interference condition.

According to an embodiment, the second communication module may select limit information corresponding to the received interference level.

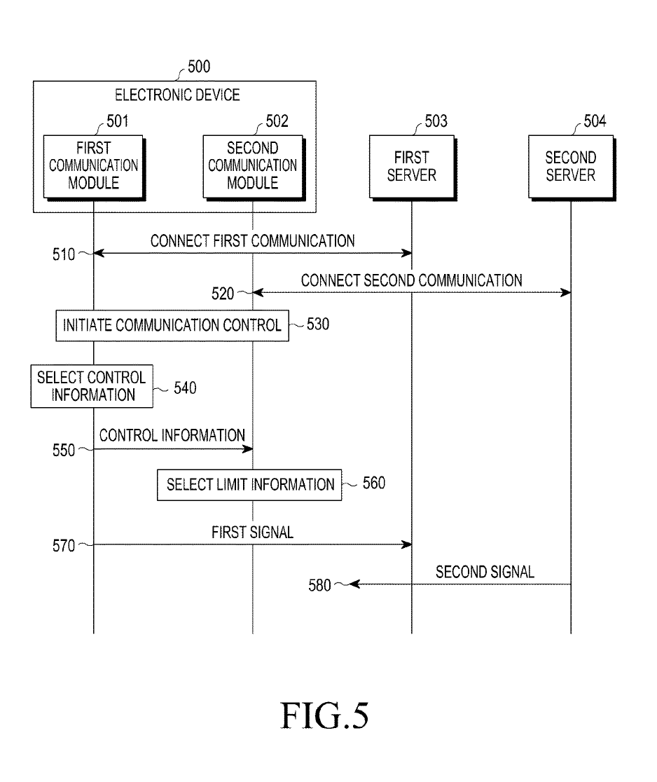

FIG. 5 is a flowchart illustrating a communication control method according to various embodiments of the present invention. An electronic device 500 may include a first communication module 501 and a second communication module 502.

In operation 510, the first communication module 501 may establish a first communication connection with a first server 503 (for example, a server of a phone network). The first communication module 501 may store first setting information of the first communication connection in a memory of the first communication module 501 and/or a memory of the electronic device 500. The first communication module 501 may transmit the first setting information to a processor of the electronic device 500 and/or the second communication module 502. The transmission of the first setting information may be initiated before and/or after the initiation of a communication control.

In operation 520, the second communication module 502 may establish a second communication connection with a second server 504 (for example, a web server). The second communication module 502 may store second setting information of the second communication connection in a memory of the second communication module 2 and/or a memory of the electronic device 500. The second communication module 502 may transmit the second setting information to a processor of the electronic device 500 and/or the first communication module 501. The transmission of the second setting information may be initiated before and/or after the initiation of a communication control.

In operation 530, the electronic device 500 may initiate the communication control of the second communication module 502. According to an embodiment, the processor may initiate the communication control of the second communication module 502 based on first communication frequency information (for example, a communication frequency, a communication frequency band, a communication channel, and the like) of the first setting information and second communication frequency information (for example, a communication frequency, a communication frequency band, a communication channel, and the like) of the second setting information. According to an embodiment, the processor may transmit an initiation command of the communication control to each of the first communication module 501 and the second communication module 502.

In operation 540, the first communication module 501 may select one of a plurality of pieces of predetermined control information for controlling a second communication operation of the second communication module 502. According to an embodiment, the first communication module 501 may select one of a plurality of predetermined interference levels based on a pre-stored second control information database (for example, the second control information database of Table 2). According to an embodiment, the first communication module 501 may receive the second setting information from the second communication module 502, identify a predetermined frequency range to which the frequency difference belongs among predetermined frequency ranges of the second control information database, identify a transmitted signal strength range to which the transmitted signal strength belongs among predetermined transmitted signal strength ranges of the second control information database, and select an interference level corresponding to the identified frequency range and the identified transmitted signal strength range.

In operation 550, the first communication module 501 may transmit information on the selected interference level to the second communication module 502 as control information.

In operation 560, the second communication module 502 may limit the second communication operation based on the received interference level. The second communication module 502 may initiate signal reception, stop signal reception, delay signal reception, or control a received signal strength according to the selected control information.

According to an embodiment, the second communication module 502 may perform a limited communication operation corresponding to the interference level of the selected control information based on a pre-stored fifth control information database (for example, the fifth control information database of Table 5).

According to an embodiment, the second communication module 502 may identify a received signal strength range to which an actual received signal strength belongs among received signal strength ranges of the fifth control information database, identify a reception capability range to which an actual reception capability belongs among predetermined reception capability ranges of the fifth control information database, and select limit information corresponding to the received interference level, the identified received signal strength and the identified reception capability range. The limit information may be initiation of signal reception, stoppage of signal reception, delaying of signal reception, or controlling of received signal strength.

In operation 570, the first communication module 501 may transmit a first signal to the first server 503 according to the first setting information.

In operation 580, the second server 504 may transmit a second signal to the second communication module 502 and the second communication module 502 may not receive the second signal according to the limit information.

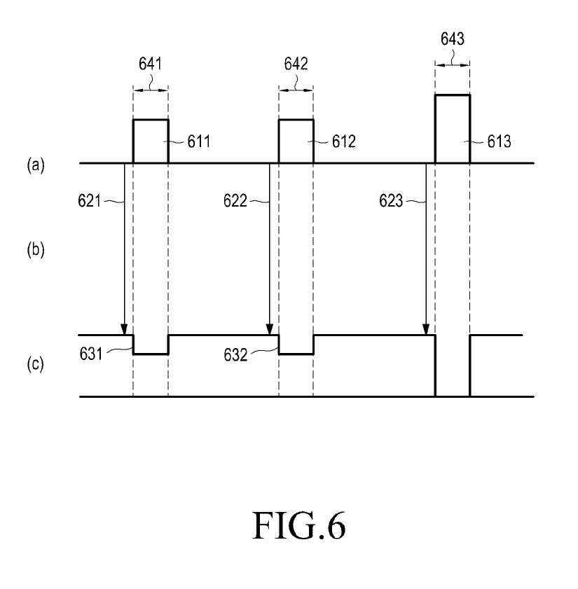

FIG. 6 illustrates a communication control method according to various embodiments of the present invention. The electronic device may include a first communication module (for example, an LTE module) and a second communication module (for example, a Wi-Fi module). FIG. 6(a) illustrates interference levels 611, 612, and 613 determined by the first communication module according to the lapse of time with respect to a horizontal axis indicating time and a vertical axis indicating an interference level size. According to the lapse of time, the first communication module may sequentially determine first, second, and third interference levels 611, 612, and 613.

Referring to FIG. 6(b), according to the lapse of time, the first communication module may sequentially transmit a first control information or signal 621 including the first interference level 611, a second control information or signal 622 including the second interference level 612, and a third control information or signal 623 including the third interference level 613 to the second communication module. According to the present embodiment, the third interference level is relatively higher than the first and second levels. The first communication module may determine the corresponding interference level before transmitting each signal, and transmit the determined interference level to the second communication module.

Referring to FIG. 6(c), the second communication module may receive signals 631 and 632 in first and second time intervals 641 and 642 according to the first and second control information 621 and 622, and may not receive a signal in a third time interval 643 according to the third control information 623. The first communication module may transmit signals in the first to third time intervals 641, 642, and 643.

For example, the first communication module (for example, the LTE module) may have a higher priority than that of the second communication module (for example, the Wi-Fi module) and may transmit a VoLTE signal, and the second communication module may receive a web signal. The first communication module may predict in advance an interference level based on at least one piece of the first and second setting information and communication capability information of the first and second communication modules. The first communication module may transmit the predicted interference level to the second communication module, and the second communication module may determine a degree of limit of the web signal (for example, whether to receive the web signal, a strength control, and the like) in consideration of the received interference level and the communication capability of the second communication module. The second communication module may determine to receive web signals in the first and second time intervals, and the reception capability in the first and second time intervals may deteriorate compared to a case where there is no interference. The second communication module may determine to not receive the web signal in the third time interval in consideration of the high interference level.

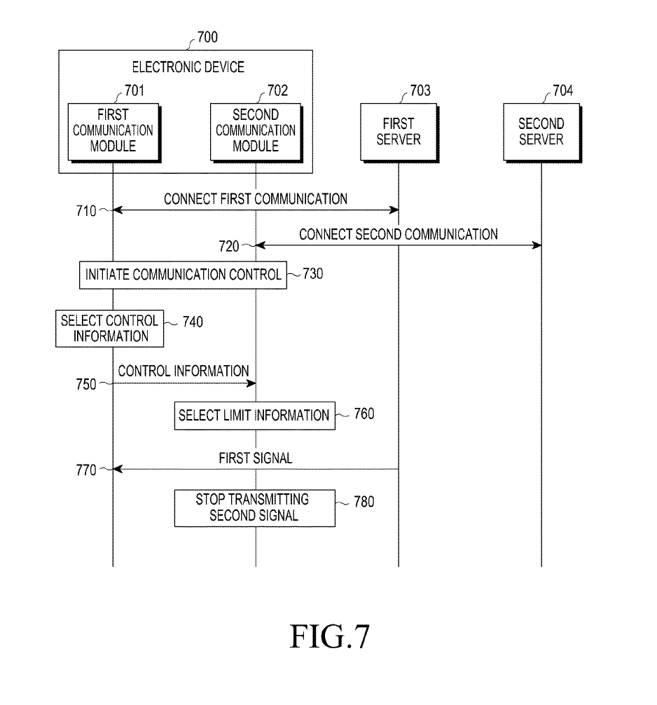

FIG. 7 is a flowchart illustrating a communication control method according to various embodiments of the present invention. An electronic device 700 may include a first communication module 701 and a second communication module 702.

In operation 710, the first communication module 701 may establish a first communication connection with a first server 703 (for example, a server of a phone network). The first communication module 701 may store first setting information of the first communication connection in a memory of the first communication module 701 and/or a memory of the electronic device 700. The first communication module 701 may transmit the first setting information to a processor of the electronic device 700 and/or the second communication module 702. The transmission of the first setting information may be initiated before and/or after the initiation of a communication control.

In operation 720, the second communication module 702 may establish a second communication connection with a second server 704 (for example, a web server). The second communication module 702 may store second setting information of the second communication connection in a memory of the second communication module 702 and/or a memory of the electronic device 700. The second communication module 702 may transmit the second setting information to a processor of the electronic device 700 and/or the first communication module 701. The transmission of the second setting information may be initiated before and/or after the initiation of a communication control.

In operation 730, the electronic device 700 may initiate the communication control of the second communication module 702. According to an embodiment, the first communication module 701 may receive second setting information of the second communication module 702, and initiate the communication control of the second communication module 702 based on first communication frequency information (for example, a communication frequency, a communication frequency band, a communication channel, and the like) of the first setting information and second communication frequency information (for example, a communication frequency, a communication frequency band, a communication channel, and the like) of the second setting information. According to an embodiment, the first communication module 701 may transmit an initiation command of the communication control to the second communication module 702.

In operation 740, the first communication module 701 may select one of a plurality of pieces of predetermined control information for controlling a second communication operation of the second communication module 702. According to an embodiment, the first communication module 701 may select one of a plurality of predetermined interference levels based on a pre-stored second control information database (for example, the fourth control information database of Table 4). According to an embodiment, the first communication module 701 may receive the second setting information from the second communication module 702, identify a predetermined frequency range to which a frequency difference between a transmission frequency and a reception frequency belongs among predetermined frequency ranges of the fourth control information database, identify a received signal strength range to which a received signal strength of the first communication module 701 belongs among predetermined received signal strength ranges of the fourth control information database, identify a reception capability range to which a reception capability of the first communication module 701 belongs among predetermined reception capability ranges of the fourth control information database, and select an interference level corresponding to the identified frequency range, the identified received signal strength range, and the identified reception capability range.

In operation 750, the first communication module 701 may transmit information on the selected interference level to the second communication module 702 as control information.

In operation 760, the second communication module 702 may limit the second communication operation based on the received interference level. The second communication module 702 may initiate signal transmission, stop signal transmission, delay signal transmission, or control a transmitted signal strength according to the selected control information.

According to an embodiment, the second communication module 702 may perform a limited communication operation corresponding to the interference level of the selected control information based on a pre-stored sixth control information database (for example, the sixth control information database of Table 6).

According to an embodiment, the second communication module 702 may select limit information corresponding to the received interference level. The limit information may be initiation of signal transmission, stoppage of signal transmission, delaying of signal transmission, or controlling of a transmitted signal strength.

In operation 770, the first communication module 701 may receive a first signal from the first server 703 according to the first setting information.

In operation 780, the second communication module 702 may not transmit a second signal to the second server 704 according to the limit information.

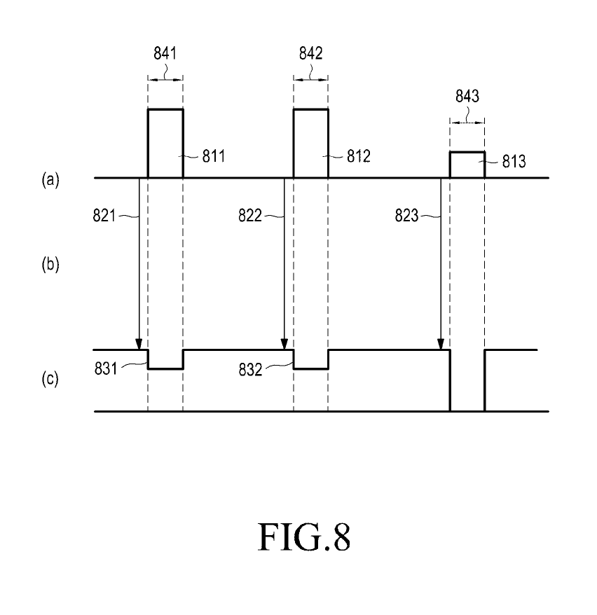

FIG. 8 illustrates a communication control method according to various embodiments of the present invention. The electronic device may include a first communication module (for example, an LTE module) and a second communication module (for example, a Wi-Fi module). FIG. 8(a) illustrates signals 811, 812, and 813 received by the first communication module according to the lapse of time with respect to a horizontal axis indicating time and a vertical axis indicating a received signal strength. According to the lapse of time, the first communication module may sequentially determine first, second, and third interference levels in consideration of received signal strengths.

Referring to FIG. 8(b), according to the lapse of time, the first communication module may sequentially transmit a first control information or signal 821 including a first interference level, a second control information or signal 822 including a second interference level, and a third control information or signal 823 including a third interference level to the second communication module. According to the present embodiment, the third interference level is relatively higher than the first and second interference levels. Before receiving each signal from the first server, the first communication module may determine the corresponding interference level and transmit the determined interference level to the second communication module.

FIG. 8(c) illustrates a signal transmitted by the second communication module according to the lapse of time with respect to a horizontal axis indicating time and a vertical axis indicating a signal strength.

Referring to FIG. 8(c), the second communication module may transmit signals 831 and 832 in first and second time intervals 841 and 842 according to first and second control information 821 and 822 and may not transmit a signal in a third time interval according to third control information 823. The first communication module may receive signals in the first to third time intervals 841, 842, and 843.

For example, the first communication module (for example, the LTE module) may have a higher priority than that of the second communication module (for example, the Wi-Fi module) and may receive a VoLTE signal, and the second communication module may transmit a web signal. The first communication module may predict in advance an acceptable interference level based on at least one piece of first and second setting information and communication capability information of the first and second communication modules. The first communication module may transmit the predicted acceptable interference level to the second communication module, and the second communication module may determine a degree of limit of the web signal (for example, whether to transmit the web signal, a strength control, and the like) in consideration of the received interference level and the communication capability of the second communication module. The second communication module may determine to transmit web signals based on strong received signal strengths in first and second time intervals. The second communication module may determine to not transmit the web signal in the third time interval in consideration of a weak received signal strength.

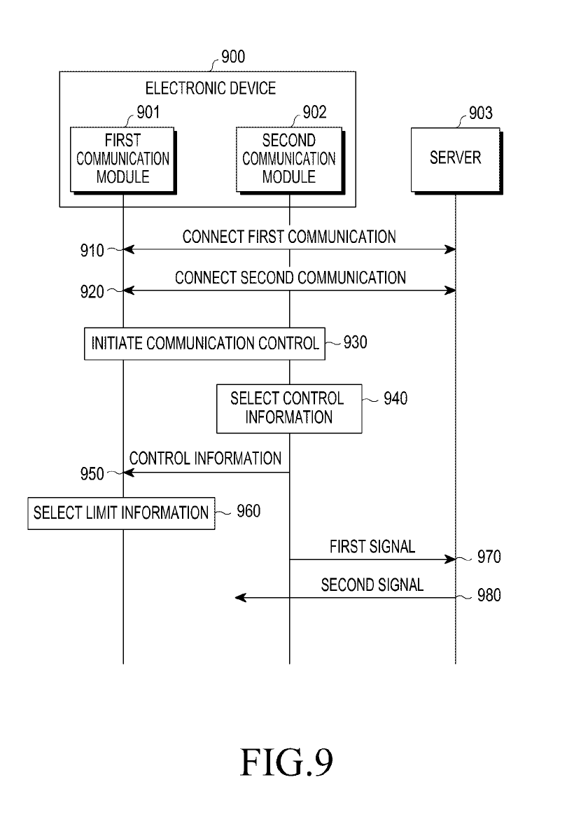

FIG. 9 is a flowchart illustrating a communication control method according to various embodiments of the present invention. An electronic device 900 may include a first communication module 901 and a second communication module 902.

In operation 910, the first communication module 901 may establish a first communication connection with a first server (for example, a server of a phone network). The first communication module 901 may store first setting information of the first communication connection in a memory of the first communication module 901 and/or a memory of the electronic device 900. The first communication module 901 may transmit the first setting information to a processor of the electronic device 900 and/or the second communication module 902. The transmission of the first setting information may be initiated before and/or after the initiation of a communication control.

In operation 920, the second communication module 902 may establish a second communication connection with a second server (for example, a web server). The second communication module 902 may store second setting information of the second communication connection in a memory of the second communication module 902 and/or a memory of the electronic device 900. The second communication module 902 may transmit the second setting information to a processor of the electronic device 900 and/or the first communication module 901. The transmission of the second setting information may be initiated before and/or after the initiation of a communication control.

In operation 930, the electronic device 900 may initiate the communication control of the second communication module 902. According to an embodiment, the processor may initiate the communication control of the second communication module 902 based on first communication frequency information (for example, a communication frequency, a communication frequency band, a communication channel, and the like) of the first setting information and second communication frequency information (for example, a communication frequency, a communication frequency band, a communication channel, and the like) of the second setting information. According to an embodiment, the processor may transmit an initiation command of the communication control to each of the first communication module 901 and the second communication module 902. According to an embodiment, the processor may allocate a higher priority to the second communication module 902.

In operation 940, the second communication module 902 may select one of a plurality of pieces of predetermined control information for controlling a first communication operation of the first communication module 901. According to an embodiment, the second communication module 902 may select one of a plurality of predetermined interference levels based on a pre-stored control information database. According to an embodiment, the second communication module 902 may receive the first setting information from the first communication module 901, identify a predetermined frequency range to which the frequency difference belongs among predetermined frequency ranges of the control information database, identify a transmitted signal strength range to which the transmitted signal strength belongs among predetermined transmitted signal strength ranges of the control information database, and select an interference level corresponding to the identified frequency range and the identified transmitted signal strength range.

In operation 950, the second communication module 902 may transmit information on the selected interference level to the first communication module 901 as control information.

In operation 960, the first communication module 901 may limit the first communication operation based on the received interference level. The first communication module 901 may initiate signal reception, stop signal reception, delay signal reception, or control a received signal strength according to the selected control information.

According to an embodiment, the first communication module 901 may perform a limited communication operation corresponding to the interference level of the selected control information based on a pre-stored control information database.

According to an embodiment, the first communication module 901 may identify a received signal strength range to which an actual received signal strength belongs among received signal strength ranges of the control information database, identify a reception capability range to which an actual reception capability belongs among predetermined reception capability ranges of the control information database, and select limit information corresponding to the received interference level, the identified received signal strength, and the identified reception capability range. The limit information may be initiation of signal reception, stoppage of signal reception, delaying of signal reception, or controlling of received signal strength.

In operation 970, the second communication module 902 may transmit a first signal to the server 903 according to the second setting information.

In operation 980, the server 903 may transmit a second signal to the first communication module 901, and the first communication module 901 may not receive the second signal according to the limit information.

For example, the first communication module 901 (for example, an LTE module) and the second communication module 902 (for example, a Wi-Fi module) may receive data from the same server or a plurality of servers. When the electronic device 900 is in area where LTE corresponds to a weak electric field and there are many users and thus a communication capability of the first communication module 901 is low and a communication capability of the second communication module 902 is high, the electronic device 900 may allocate a higher priority to the second communication module 902 than the first communication module 901, the second communication module 902 may normally transmit and receive data, and the first communication module 901 may transmit and receive data according to a communication state or a control of the second communication module 902.

The priorities of the first and second communication modules 901 and 902 may be determined according to applications, services, and communication capabilities. According to an embodiment, the processor may allocate priorities to the first and second communication modules 901 and 902 according to applications or services. According to an embodiment, the priorities may be changed by negotiation between the first and second communication modules 901 and 902. For example, the second communication module 902 may make a request for changing the priority to the first communication module 901 or the first communication module 901 may make a request for changing the priority to the second communication module 902.

According to various embodiments of the present invention, a method of performing communication by an electronic device may include: an operation of acquiring first setting information of a first communication operation of a first communication module arranged within the electronic device; an operation of acquiring second setting information of a second communication operation of a second communication module arranged within the electronic device; an operation of selecting one of a plurality of pieces of predetermined control information for controlling the second communication operation based on at least one piece of the first setting information and the second setting information; and an operation of limiting the second communication operation based on the selected control information.

According to various embodiments of the present invention, the first setting information may include at least one of a communication channel, a communication frequency, a communication frequency band, a communication frequency bandwidth, a communication signal strength, and a communication capability, and the second setting information may include at least one of a communication channel, a communication frequency, a communication frequency band, a communication frequency bandwidth, a communication signal strength, and a communication capability.

According to various embodiments of the present invention, the method may further include an operation of comprising comparing communication frequency information of the first setting information and communication frequency information of the second setting information, and the operation of selecting one of the plurality of pieces of control information may be initiated based on a result of comparison.

According to various embodiments of the present invention, the method may further include an operation of comprising comparing at least one piece of communication frequency information of the first setting information and communication frequency information of the second setting information with at least one predetermined range or at least one value, and the operation of selecting one of the plurality of pieces of control information may be initiated based on a result of comparison.

According to various embodiments of the present invention, the method may further include an operation of determining a difference between a communication frequency of the first setting information and a communication frequency of the second setting information, and an operation of comparing the difference with a predetermined threshold value, and the operation of selecting one of the plurality of pieces of control information may be initiated when the difference is equal to or smaller than the predetermined threshold value.

According to various embodiments of the present invention, the first setting information may include at least one piece of communication frequency information, communication signal strength information, and communication capability information, the second setting information may include at least one piece of communication frequency information, communication signal strength information, and communication capability information, and one of the plurality of pieces of control information may be selected based on at least one piece of the communication frequency information of the first setting information, the communication signal strength information of the first setting information, the communication capability information of the first setting information, the communication frequency information of the second setting information, the communication signal strength information of the second setting information, the communication capability information of the second setting information.

According to various embodiments of the present invention, the first setting information may include communication frequency information and communication signal strength information, the second setting information may include communication frequency information and communication signal strength information, and one of the plurality of pieces of control information may be selected based on a result of a comparison between the communication frequency information of the first setting information and the communication frequency information of the second setting information or a comparison between the communication frequency information and predetermined ranges or values, and a result of a comparison between the communication signal strength information of the first setting information and the communication signal strength information of the second setting information, or a comparison between the communication signal strength information and predetermined ranges or values.

According to various embodiments of the present invention, the first setting information may include at least one piece of communication frequency information, communication signal strength information, and communication capability information, the second setting information may include at least one piece of communication frequency information, communication signal strength information, and communication capability information, the operation of selecting one of the plurality of pieces of control information may include an operation of selecting one of a plurality of predetermined interference levels for indicating a degree of interference which a transmitted signal gives to a received signal based on at least one piece of the communication frequency information of the first setting information, the communication signal strength information of the first setting information, and the communication capability information of the first setting information, the communication frequency information of the second setting information, the communication signal strength information of the second setting information, and the communication capability information of the second setting information, and the second communication operation of the second communication module may be limited based on the selected interference level.

According to various embodiments of the present invention, the operation of selecting one of the plurality of pieces of control information may include an operation of selecting one of a plurality of predetermined interference levels for indicating a degree of interference which a transmitted signal gives to a received signal based on at least one piece of reception frequency information, received signal strength information, transmission frequency information, and transmitted signal strength information of the first and second setting information, and the operation of limiting the second communication operation may include an operation of comparing the received signal strength information with at least one range or at least one value predetermined in connection with the selected interference level, and an operation of limiting the second communication operation based on a result of the comparison.

According to various embodiments of the present invention, the plurality of pieces of control information may correspond to a plurality of predetermined interference levels for indicating a degree of interference which a transmitted signal gives to a received signal, a plurality of control commands or control values related to signal transmission or reception, or a plurality of limited conditions or allowed conditions related to the signal transmission or reception, and the limiting of the second communication operation corresponds to initiating signal transmission, stopping signal transmission, delaying signal transmission, controlling a transmitted signal strength, initiating signal reception, stopping signal reception, delaying signal reception, and controlling a received signal strength.

According to various embodiments of the present invention, the plurality of pieces of control information may correspond to a plurality of predetermined interference levels for indicating a degree of interference which a transmitted signal gives to a received signal, a plurality of control commands or control values related to signal transmission or reception, or a plurality of limited conditions or allowed conditions related to the signal transmission or reception, and the operation of limiting the second communication operation may include an operation of transmitting, to the second communication module, an interference level selected from the plurality of interference levels, a control command or a control value selected from the plurality of control commands or control values, or a limited condition or an allowed condition selected from the plurality of limited conditions or allowed conditions.

According to various embodiments of the present invention, the method may further include an operation of allocating a priority to each of the first communication module and the second communication module, and the first communication module may have a higher priority than that of the second communication module.

According to various embodiments of the present invention, the operation of selecting one of the plurality of pieces of control information may include an operation of selecting one of a plurality of predetermined interference levels for indicating a degree of interference which a transmitted signal gives to a received signal based on at least one piece of reception frequency information, received signal strength information, transmission frequency information, and transmitted signal strength information included in the first and second setting information, and the operation of limiting the second communication operation may include an operation of comparing the received signal strength information with at least one range or at least one value predetermined in connection with the selected interference level and an operation of limiting the second communication operation based on a result of the comparison, and reception capability information predetermined in connection with the received signal strength information and the selected interference level.

According to various embodiments of the present invention, the operation of selecting one of the plurality of pieces of control information may include an operation of selecting one of a plurality of predetermined interference levels for indicating a degree of interference which a transmitted signal gives to a received signal based on at least one piece of reception frequency information, received signal strength information, transmission frequency information, and transmitted signal strength information of the first and second setting information, and the operation of limiting the second communication operation may include an operation of determining a reception capability of the second communication operation based on reception capability information predetermined in connection with the received signal strength information and the selected interference level, an operation of comparing the reception capability with at least one predetermined range or at least one value, and an operation of controlling a signal reception operation of the second communication module based on a result of the comparison.

According to various embodiments of the present invention, the operation of selecting one of the plurality of pieces of control information may include an operation of selecting an interference level corresponding to a maximum interference degree allowed in the first communication operation among a plurality of predetermined interference levels for indicating a degree of interference which a transmitted signal gives to a received signal, and the operation of limiting the second communication operation may include an operation of limiting a signal transmission operation of the second communication module based on a transmitted signal strength range allowed for the selected interference level.

According to various embodiments of the present invention, an electronic device may include: a first communication module that performs a first communication operation; and a second communication module that performs a second communication operation, wherein the electronic device acquires first setting information of a first communication operation, acquires second setting information of a second communication operation, selects one of a plurality of pieces of predetermined control information for controlling the second communication operation based on at least one piece of the first setting information and the second setting information, and limits the second communication operation based on the selected control information.

According to various embodiments of the present invention, the electronic device may compare communication frequency information of the first setting information and communication frequency information of the second setting information, and initiate the selecting of one of the plurality of pieces of control information based on a result of comparison.

According to various embodiments of the present invention, the electronic device may compare at least one piece of communication frequency information of the first setting information and communication frequency information of the second setting information with at least one predetermined range or at least one value, and initiate the selecting of one of the plurality of pieces of control information based on a result of the comparison.

According to various embodiments of the present invention, the electronic device may determine a difference between a communication frequency of the first setting information and a communication frequency of the second setting information, compare the difference with a predetermined threshold value, and initiate the selecting of one of the plurality of pieces of control information when the difference is equal to or smaller than the predetermined threshold value.

According to various embodiments of the present invention, the first setting information may include at least one piece of communication frequency information, communication signal strength information, and communication capability information, the second setting information may include at least one piece of communication frequency information, communication signal strength information, and communication capability information, and the electronic device may select one of a plurality of predetermined interference levels for indicating a degree of interference which a transmitted signal gives to a received signal based on at least one piece of the communication frequency information of the first setting information, the communication signal strength information of the first setting information, and the communication capability information of the first setting information, the communication frequency information of the second setting information, the communication frequency information of the second setting information, and the communication capability information of the second setting information, and limit the second communication operation of the second communication module based on the selected interference level.

According to various embodiments of the present invention, the electronic device may select one of a plurality of predetermined interference levels for indicating a degree of interference which a transmitted signal gives to a received signal based on at least one piece of reception frequency information, received signal strength information, transmission frequency information, and transmitted signal strength information of the first and second setting information, compare the received signal strength information with at least one range or at least one value predetermined in connection with the selected interference level, and limit the second communication operation based on a result of the comparison.

According to various embodiments of the present invention, the electronic device may allocate a priority to each of the first communication module and the second communication module, and the first communication module may have a higher priority than that of the second communication module.

According to various embodiments of the present invention, the electronic device may select one of a plurality of predetermined interference levels for indicating a degree of interference which a transmitted signal gives to a received signal based on at least one piece of reception frequency information, received signal strength information, transmission frequency information, and transmitted signal strength information included in the first and second setting information, compare the received signal strength information with at least one range or at least one value predetermined in connection with the selected interference level, and limit the second communication operation based on a result of the comparison, and reception capability information predetermined in connection with the received signal strength information and the selected interference level

According to various embodiments of the present invention, the electronic device may select one of a plurality of predetermined interference levels for indicating a degree of interference which a transmitted signal gives to a received signal based on at least one piece of reception frequency information, received signal strength information, transmission frequency information, and transmitted signal strength information of the first and second setting information, determine a reception capability of the second communication operation based on reception capability information predetermined in connection with the received signal strength information and the selected interference level, compare the reception capability with at least one predetermined range or at least one value, and control a signal reception operation of the second communication module based on a result of the comparison.

According to various embodiments of the present invention, the electronic device may select an interference level corresponding to a maximum interference degree allowed in the first communication operation among a plurality of predetermined interference levels for indicating a degree of interference which a transmitted signal gives to a received signal, and control a signal transmission operation of the second communication module based on a transmitted signal strength range allowed for the selected interference level.

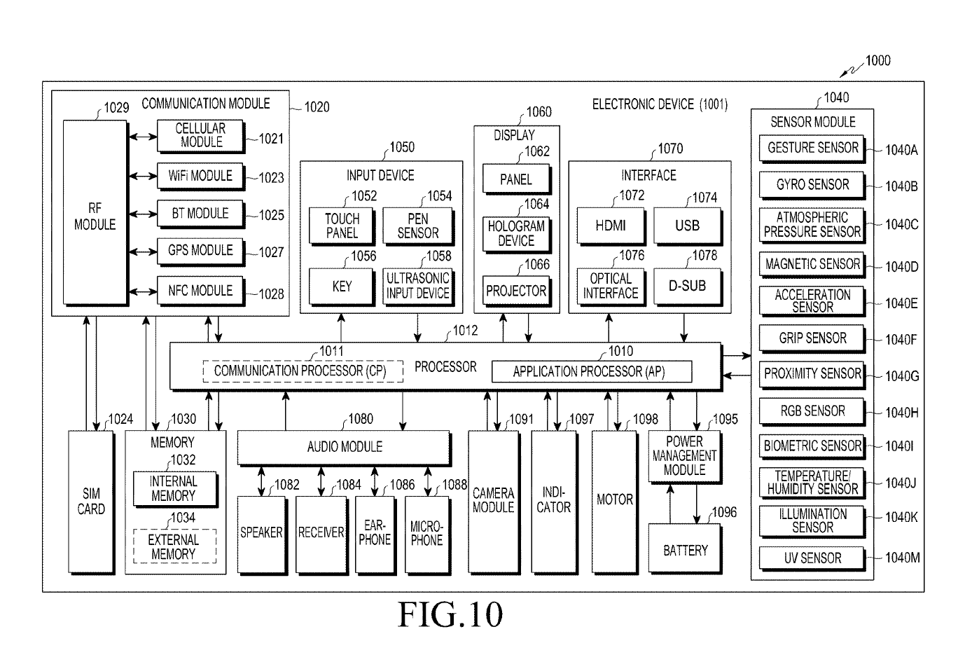

FIG. 10 is a block diagram 1000 of an electronic device 1001 according to various embodiments of the present invention. The electronic device 1001 may form, for example, a part or the entirety of the electronic device 101 illustrated in FIG. 1. Referring to FIG. 10, the electronic device 1001 may include a processor 1012 including one or more Application Processors (APs) 1010 and/or one or more Communication Processors (CPs) 1011, a communication module 1020, a Subscriber Identifier Module (SIM) card 1024, a memory 1030, a sensor module 1040, an input device 1050, a display 1060, an interface 1070, an audio module 1080, a camera module 1091, a power management module 1095, a battery 1096, an indicator 1097, and a motor 1098.

The AP 1010 may control a plurality of hardware or software elements connected thereto by driving an operating system or an application program, and may perform processing and operations on various types of data that includes multimedia data. The AP 1010 may be implemented by, for example, a System on Chip (SoC). According to an embodiment, the AP 1010 may further include a Graphic Processing Unit (GPU) (not shown).

The communication module 1020 (for example, the communication interface 160) may perform data transmission/reception in communication between the electronic device 1001 (for example, the electronic device 101) and other electronic devices (for example, the electronic device 104 and the server 106) connected thereto through a network. According to an embodiment, the communication module 1020 may include a cellular module 1021, a WiFi module 1023, a BlueTooth (BT) module 1025, a Global Positioning System (GPS) module 1027, a Near Field Communication (NFC) module 1028, and a Radio Frequency (RF) module 1029.

The cellular module 1021 may provide at least one of a voice call, a video call, a message service, and an Internet service through a communication network (for example, LTE, LTE-A, CDMA, WCDMA, UMTS, WiBro, GSM, or the like). Also, the cellular module 1021 may identify and authenticate an electronic device in a communication network using, for example, a subscriber identification module (for example, the SIM card 1024). According to an embodiment, the cellular module 1021 may perform at least some of functions which the AP 1010 may provide. For example, the cellular module 1021 may perform at least a part of the multimedia control function.

According to an embodiment, the CP 1011 may be included in the cellular module 1021. Furthermore, the cellular module 1021 may be implemented by, for example, an SoC. Although the elements, such as the cellular module 1021 (for example, communication processor), the memory 1030, the power managing module 1095, and the like, are illustrated as separate elements from the AP 1010 in FIG. 10, the AP 1010 may be implemented to include at least some (for example, the cellular module 1021) of the above-described elements according to an embodiment.

According to an embodiment, the AP 1010 or the cellular module 1021 (for example, communication processor 1011) may load a command or data received from at least one of a non-volatile memory and other component elements connected to each of the AP 1010 and the cellular module 1021 to a volatile memory and process the loaded command or data. Furthermore, the AP 1010 or the cellular module 1021 may store, in a non-volatile memory, data received from or generated by at least one of the other elements.

Each of the Wi-Fi module 1023, the BT module 1025, the GPS module 1027, or the NFC module 1028 may include, for example, a processor for processing data transmitted/received through a corresponding module. Although the cellular module 1021, the Wi-Fi module 1023, the BT module 1025, the GPS module 1027, and the NFC module 1028 are illustrated as individual blocks in FIG. 10, at least some (for example, two or more) of the cellular module 1021, the Wi-Fi module 1023, the BT module 1025, the GPS module 1027, and the NFC module 1028 may be included within one Integrated Chip (IC) or one IC package. For example, at least some of the processors that correspond to the cellular module 1021, the Wi-Fi module 1023, the BT module 1025, the GPS module 1027, and the NFC module 1028 (for example, a communication processor that corresponds to the cellular module 1021 and a Wi-Fi processor that corresponds to the Wi-Fi module 1023) may be implemented as one SoC.

The RF module 1029 may transmit/receive data, for example, an RF signal. Although not illustrated, the RF module 1029 may include at least one of, for example, a transceiver, a Power Amp Module (PAM), a frequency filter, a Low Noise Amplifier (LNA) and the like. The RF module 1029 may further include a component for transmitting/receiving an electromagnetic wave in free air space in radio communication, such as at least one of a conductor, a conducting wire and the like. Although the cellular module 1021, the Wi-Fi module 1023, the BT module 1025, the GPS module 1027, and the NFC module 1028 are illustrated to share one RF module 1029 in FIG. 10, at least one of the cellular module 1021, the Wi-Fi module 1023, the BT module 1025, the GPS module 1027, and the NFC module 1028 may transmit/receive the RF signal through a separate RF module.

The SIM card 1024 may be a card including a subscriber identification module and may be inserted into a slot formed in a particular portion of the electronic device. The SIM card 1024 may include unique identification information (for example, an Integrated Circuit Card IDentifier (ICCID)) or subscriber information (for example, an International Mobile Subscriber IDentity (IMSI)).

The memory 1030 (for example, the memory 130) may include an internal memory 1032 or an external memory 1034. The internal memory 1032 may include at least one of a volatile memory (for example, a Dynamic Random Access Memory (DRAM), a Static RAM (SRAM), a Synchronous Dynamic RAM (SDRAM), and the like) and a non-volatile memory (for example, a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a NAND flash memory, a NOR flash memory, and the like).

According to an embodiment, the internal memory 1032 may be a Solid State Drive (SSD). The external memory 1034 may further include a flash drive, for example, at least one of a Compact Flash (CF), a Secure Digital (SD), a Micro Secure Digital (Micro-SD), a Mini Secure Digital (Mini-SD), an extreme Digital (xD), a memory stick and the like. The external memory 1034 may be functionally connected to the electronic device 1001 through various interfaces. According to an embodiment, the electronic device 1001 may further include a storage device (or storage medium) such as a hard drive.

The sensor module 1040 may measure a physical quantity or detect an operating state of the electronic device 1001, and convert the measured or detected information into an electronic signal. The sensor module 1040 may include at least one of, for example, a gesture sensor 1040A, a gyro sensor 1040B, an atmospheric pressure sensor 1040C, a magnetic sensor 1040D, an acceleration sensor 1040E, a grip sensor 1040F, a proximity sensor 1040G, a color sensor 1040H (for example, a Red/Green/Blue (RGB) sensor), a biometric sensor 10401, a temperature/humidity sensor 1040J, an illumination sensor 1040K, and an Ultra Violet (UV) sensor 1040M. Additionally or alternatively, the sensor module 1040 may include, for example, an E-nose sensor (not illustrated), an electromyography (EMG) sensor (not illustrated), an electroencephalogram (EEG) sensor (not illustrated), an electrocardiogram (ECG) sensor (not illustrated), an Infrared (IR) sensor, an iris sensor (not illustrated), a fingerprint sensor and the like. The sensor module 1040 may further include a control circuit for controlling at least one sensor included therein.

The input device 1050 may include a touch panel 1052, a (digital) pen sensor 1054, a key 1056, or an ultrasonic input device 1058. The touch panel 1052 may recognize a touch input through at least one of, for example, a capacitive type, a resistive type, an infrared type, and an ultrasonic type. The touch panel 1052 may further include a control circuit. In the case of the capacitive type, physical contact or proximity recognition is possible. The touch panel 1052 may further include a tactile layer. In this case, the touch panel 1052 may provide a tactile reaction to a user.

The (digital) pen sensor 1054 may be implemented, for example, using a method that is the same as or similar to receiving a user's touch input, or using a separate recognition sheet. The key 1056 may include, for example, a physical button, an optical key or a keypad. The ultrasonic input device 1058 is a unit that may identify data by generating an ultrasonic signal through an input tool and detecting a sonic wave through a microphone (for example, a microphone 1088) in the electronic device 1001, and is capable of wireless recognition. According to an embodiment, the electronic device 1001 may receive a user input from an external device (for example, computer or server) connected to the electronic device 1001 by using the communication module 1020.

The display 1060 (for example, the display 100) may include a panel 1062, a hologram device 1064, and a projector 1066. The panel 1062 may be, for example, a Liquid Crystal Display (LCD), an Active Matrix Organic Light Emitting Diode (AM-OLED), or the like. The panel 1062 may be implemented to be, for example, flexible, transparent, or wearable. The panel 1062 may also be integrated with the touch panel 1052 as a single module. The hologram device 1064 may show a stereoscopic image in the air by using interference of light. The projector 1066 may project light onto a screen to display an image. For example, the screen may be located inside or outside the electronic device 1001. According to an embodiment, the display 1060 may further include a control circuit for controlling the panel 1062, the hologram device 1064, or the projector 1066.

The interface 1070 may include, for example, a High-Definition Multimedia Interface (HDMI) 1072, a Universal Serial Bus (USB) 1074, an optical interface 1076, or a D-subminiature (D-sub) 1078. The interface 1070 may be included in, for example, the communication interface 160 illustrated in FIG. 1. Additionally or alternatively, the interface 1070 may include, for example, a Mobile High-definition Link (MHL) interface, a Secure Digital (SD) card/Multi-Media Card (MMC) interface, or an Infrared Data Association (IrDA) standard interface.

The audio module 1080 may bilaterally convert a sound and an electrical signal. At least some elements of the audio module 1080 may be included in, for example, the input/output interface 140 illustrated in FIG. 1. The audio module 1080 may process sound information input or output through, for example, at least one of a speaker 1082, a receiver 1084, earphones 1086, and the microphone 1088.

The camera module 1091 is a device which may photograph a still image and a video. According to an embodiment of the present invention, the camera module 291 may include one or more image sensors (for example, a front sensor or a rear sensor), a lens (not illustrated), an Image Signal Processor (ISP) (not illustrated) or a flash (not illustrated) (for example, an LED or xenon lamp).

The power management module 1095 may manage electric power of the electronic device 1001. Although not illustrated, the power management module 1095 may include, for example, a Power Management Integrated Circuit (PMIC), a charger Integrated Circuit (IC), or a battery or fuel gauge.

The PMIC may be mounted, for example, in integrated circuits or SoC semiconductors. The charging methods may be classified into wired charging and wireless charging. The charger IC may charge a battery and prevent inflow of excessive voltage or excessive current from a charger. According to one embodiment, the charger IC may include a charger IC for at least one of the wired charging method and the wireless charging method. Examples of the wireless charging may include magnetic resonance charging, magnetic induction charging, and electromagnetic charging, and an additional circuit such as a coil loop, a resonance circuit, a rectifier or the like may be added for the wireless charging.

The battery gauge may measure, for example, the remaining amount of battery or a voltage, current, or temperature during charging. The battery 1096 may store or generate electricity and supply power to the electronic device 1001 using the stored or generated electricity. The battery 1096 may include, for example, a rechargeable battery or a solar battery.

The indicator 1097 may display a particular status of the electronic device 1001 or a part thereof (for example, the AP 1010), for example, at least one of a booting status, a message status, a charging status and the like. The motor 1098 may convert an electrical signal into mechanical vibration. Although not illustrated, the electronic device 1001 may include a processing device (for example, a GPU) for supporting a mobile TV. The processing device for supporting the mobile TV may process media data according to standards, for example, a digital multimedia broadcasting (DMB), a digital video broadcasting (DVB), a media flow, or the like.

The above described components of the electronic device according to various embodiments of the present invention may be formed of one or more components, and a name of a corresponding component element may be changed based on the type of electronic device. The electronic device according to the present invention may include one or more of the aforementioned components or may further include other additional components, or some of the aforementioned components may be omitted. Further, some of the components of the electronic device according to the various embodiments of the present invention may be combined to form a single entity, and thus, may equivalently execute functions of the corresponding elements prior to the combination.

The “module” used in various embodiments of the present invention may refer to, for example, a “unit” including one of hardware, software, and firmware, or a combination of two or more of the hardware, software, and firmware. The “module” may be interchangeably used with a term, such as unit, logic, logical block, component, or circuit. The “module” may be the smallest unit of an integrated component or a part thereof. The “module” may be the smallest unit that performs one or more functions or a part thereof. The “module” may be mechanically or electronically implemented. For example, the “module” according to various embodiments of the present invention may include at least one of an Application-Specific Integrated Circuit (ASIC) chip, a Field-Programmable Gate Arrays (FPGAs), and a programmable-logic device for performing operations which have been known or are to be developed hereafter.

According to various embodiments, at least a part of a device (for example, modules or functions thereof) or a method (for example, operations) according to the various embodiments of the present invention may be embodied by, for example, a command stored in a computer readable storage medium in a form of a programming module. When the command is executed by one or more processors (for example, the processor 120), the one or more processors may execute a function corresponding to the command. The computer-readable storage medium may, for example, be the memory 130. At least some of the programming modules may be implemented (for example, executed) by, for example, the processor 120. At least some of the programming modules may include, for example, a module, a program, a routine, a set of instructions or a process for performing one or more functions.

The computer readable recording medium may include magnetic media such as a hard disc, a floppy disc, and a magnetic tape, optical media such as a compact disc read only memory (CD-ROM) and a digital versatile disc (DVD), magneto-optical media such as a floptical disk, and hardware devices specifically configured to store and execute program commands, such as a read only memory (ROM), a random access memory (RAM), and a flash memory. In addition, the program instructions may include high class language codes, which can be executed in a computer by using an interpreter, as well as machine codes made by a compiler. The aforementioned hardware device may be configured to operate as one or more software modules in order to perform the operation of the present invention, and vice versa.

A module or a programming module according to the present invention may include at least one of the described component elements, a few of the component elements may be omitted, or additional component elements may be included. Operations executed by a module, a programming module, or other component elements according to various embodiments of the present invention may be executed sequentially, in parallel, repeatedly, or in a heuristic manner. Further, some operations may be executed according to another order or may be omitted, or other operations may be added.

According to various embodiments of the presnet invention, a storage medium having instructions stored therein is provided. The instructions are configured to, when executed by at least one processor, cause the processor to perform at least one operation. The at least one operation may include: acquiring first setting information of a first communication operation of a first communication module arranged within the electronic device; acquiring second setting information of a second communication operation of a second communication module arranged within the electronic device; selecting one of a plurality of pieces of predetermined control information for controlling the second communication operation based on at least one piece of the first setting information and the second setting information; and limiting the second communication operation based on the selected control information.

The embodiments of the present invention disclosed in the specification and the drawings are only particular examples proposed in order to easily describe the technical matters of the present invention and help with comprehension of the present invention, and do not limit the scope of the present invention. Therefore, in addition to the embodiments disclosed herein, the scope of the various embodiments of the present invention should be construed to include all modifications or modified forms drawn based on the technical idea of the various embodiments of the present invention.

1. A method of performing communication by an electronic device, the method comprising:
acquiring first setting information of a first communication operation of a first communication module arranged within the electronic device;
acquiring second setting information of a second communication operation of a second communication module arranged within the electronic device;
selecting one of a plurality of pieces of predetermined control information for controlling the second communication operation based on at least one piece of the first setting information and the second setting information; and
limiting the second communication operation based on the selected control information.

2. The method of claim 1, wherein the first setting information includes at least one of a communication channel, a communication frequency, a communication frequency band, a communication frequency bandwidth, a communication signal strength, and a communication capability, and
the second setting information includes at least one of a communication channel, a communication frequency, a communication frequency band, a communication frequency bandwidth, a communication signal strength, and a communication capability.

3. The method of claim 1, further comprising comparing communication frequency information of the first setting information and communication frequency information of the second setting information,
wherein the selecting of one of the plurality of pieces of control information is initiated based on a result of comparison.

4. The method of claim 1, further comprising comparing at least one piece of communication frequency information of the first setting information and communication frequency information of the second setting information with at least one predetermined range or at least one value,
wherein the selecting of one of the plurality of pieces of control information is initiated based on a result of the comparison.

5. The method of claim 1, further comprising:
determining a difference between a communication frequency of the first setting information and a communication frequency of the second setting information; and
comparing the difference with a predetermined threshold value,
wherein the selecting of one of the plurality of pieces of control information is initiated when the difference is equal to or smaller than the predetermined threshold value.

6. The method of claim 1, wherein the first setting information includes at least one piece of communication frequency information, communication signal strength information, and communication capability information,
the second setting information includes at least one piece of communication frequency information, communication signal strength information, and communication capability information, and
one of the plurality of pieces of control information is selected based on at least one piece of the communication frequency information of the first setting information, the communication signal strength information of the first setting information, the communication capability information of the first setting information, the communication frequency information of the second setting information, the communication signal strength information of the second setting information, the communication capability information of the second setting information.

7. The method of claim 1, wherein the first setting information includes communication frequency information and communication signal strength information,
the second setting information includes communication frequency information and communication signal strength information, and
one of the plurality of pieces of control information is selected based on a result of a comparison between the communication frequency information of the first setting information and the communication frequency information of the second setting information, or a comparison between the communication frequency information and predetermined ranges or values, and a result of a comparison between the communication signal strength information of the first setting information and the communication signal strength information of the second setting information, or a comparison between the communication signal strength information and predetermined ranges or values.

8. The method of claim 1, wherein the first setting information includes at least one piece of communication frequency information, communication signal strength information, and communication capability information,
the second setting information includes at least one piece of communication frequency information, communication signal strength information, and communication capability information,
the selecting of one of the plurality of pieces of control information comprises selecting one of a plurality of predetermined interference levels for indicating a degree of interference which a transmitted signal gives to a received signal based on at least one piece of the communication frequency information of the first setting information, the communication signal strength information of the first setting information, and the communication capability information of the first setting information, the communication frequency information of the second setting information, the communication signal strength information of the second setting information, and the communication capability information of the second setting information, and
the second communication operation of the second communication module is limited based on the selected interference level.

9. The method of claim 1, wherein the selecting of one of the plurality of pieces of control information comprises selecting one of a plurality of predetermined interference levels for indicating a degree of interference which a transmitted signal gives to a received signal based on at least one piece of reception frequency information, received signal strength information, transmission frequency information, and transmitted signal strength information of the first and second setting information, and
limiting of the second communication operation comprises:
comparing the received signal strength information with at least one range or at least one value predetermined in connection with the selected interference level; and
limiting the second communication operation based on a result of the comparison.

10. The method of claim 1, wherein the plurality of pieces of control information correspond to a plurality of predetermined interference levels for indicating a degree of interference which a transmitted signal gives to a received signal, a plurality of control commands or control values related to signal transmission or reception, or a plurality of limited conditions or allowed conditions related to the signal transmission or reception, and
the limiting of the second communication operation corresponds to initiating signal transmission, stopping signal transmission, delaying signal transmission, controlling a transmitted signal strength, initiating signal reception, stopping signal reception, delaying signal reception, and controlling a received signal strength.

11. The method of claim 1, wherein the plurality of pieces of control information correspond to a plurality of predetermined interference levels for indicating a degree of interference which a transmitted signal gives to a received signal, a plurality of control commands or control values related to signal transmission or reception, or a plurality of limited conditions or allowed conditions related to the signal transmission or reception, and
the limiting of the second communication operation comprises transmitting, to the second communication module, an interference level selected from the plurality of interference levels, a control command or a control value selected from the plurality of control commands or control values, or a limited condition or an allowed condition selected from the plurality of limited conditions or allowed conditions.

12. The method of claim 1, further comprising allocating a priority to each of the first communication module and the second communication module,
wherein the first communication module has a higher priority than that of the second communication module.

13. The method of claim 1, wherein the selecting of one of the plurality of pieces of control information comprises selecting one of a plurality of predetermined interference levels for indicating a degree of interference which a transmitted signal gives to a received signal based on at least one piece of reception frequency information, received signal strength information, transmission frequency information, and transmitted signal strength information included in the first and second setting information, and
the limiting of the second communication operation comprises:
comparing the received signal strength information with at least one range or at least one value predetermined in connection with the selected interference level; and
limiting the second communication operation based on a result of the comparison, and reception capability information predetermined in connection with the received signal strength information and the selected interference level.

14. The method of claim 1, wherein the selecting of one of the plurality of pieces of control information comprises selecting one of a plurality of predetermined interference levels for indicating a degree of interference which a transmitted signal gives to a received signal based on at least one piece of reception frequency information, received signal strength information, transmission frequency information, and transmitted signal strength information of the first and second setting information, and
the limiting of the second communication operation comprises:
determining a reception capability of the second communication operation based on reception capability information predetermined in connection with the received signal strength information and the selected interference level;
comparing the reception capability with at least one predetermined range or at least one value; and
controlling a signal reception operation of the second communication module based on a result of the comparison.

15. The method of claim 1, wherein the selecting of one of the plurality of pieces of control information comprises selecting an interference level corresponding to a maximum interference degree allowed in the first communication operation among a plurality of predetermined interference levels for indicating a degree of interference which a transmitted signal gives to a received signal, and
the limiting of the second communication operation comprises limiting a signal transmission operation of the second communication module based on a transmitted signal strength range allowed for the selected interference level.

16. A machine-readable storage medium recording a program for executing a communication method of an electronic device, the communication method comprising:
acquiring first setting information of a first communication operation of a first communication module arranged within the electronic device;
acquiring second setting information of a second communication operation of a second communication module arranged within the electronic device;
selecting one of a plurality of pieces of predetermined control information for controlling the second communication operation based on at least one piece of the first setting information and the second setting information; and
limiting the second communication operation based on the selected control information.

17. An electronic device comprising:
a first communication module that performs a first communication operation; and
a second communication module that performs a second communication operation,
wherein the electronic device acquires first setting information of a first communication operation, acquires second setting information of a second communication operation, selects one of a plurality of pieces of predetermined control information for controlling the second communication operation based on at least one piece of the first setting information and the second setting information, and limits the second communication operation based on the selected control information.

18. The electronic device of claim 17, wherein the first setting information includes at least one of a communication channel, a communication frequency, a communication frequency band, a communication frequency bandwidth, a communication signal strength, and a communication capability, and
the second setting information includes at least one of a communication channel, a communication frequency, a communication frequency band, a communication frequency bandwidth, a communication signal strength, and a communication capability.

19. The electronic device of claim 17, wherein the electronic device compares communication frequency information of the first setting information and communication frequency information of the second setting information, and initiates the selecting of one of the plurality of pieces of control information based on a result of comparison.

20. The electronic device of claim 17, wherein the electronic device compares at least one piece of communication frequency information of the first setting information and communication frequency information of the second setting information with at least one predetermined range or at least one value, and initiates the selecting of one of the plurality of pieces of control information based on a result of the comparison.

21. The electronic device of claim 17, wherein the electronic device determines a difference between a communication frequency of the first setting information and a communication frequency of the second setting information, compares the difference with a predetermined threshold value, and initiates the selecting of one of the plurality of pieces of control information when the difference is equal to or smaller than the predetermined threshold value.

22. The electronic device of claim 17, wherein the first setting information includes at least one piece of communication frequency information, communication signal strength information, and communication capability information,
the second setting information includes at least one piece of communication frequency information, communication signal strength information, and communication capability information, and
one of the plurality of pieces of control information is selected based on at least one piece of the communication frequency information of the first setting information, the communication signal strength information of the first setting information, the communication capability information of the first setting information, the communication frequency information of the second setting information, the communication signal strength information of the second setting information, the communication capability information of the second setting information.

23. The electronic device of claim 17, wherein the first setting information includes communication frequency information and communication signal strength information,
the second setting information includes communication frequency information and communication signal strength information, and
one of the plurality of pieces of control information is selected based on a result of a comparison between the communication frequency information of the first setting information and the communication frequency information of the second setting information or a comparison between the communication frequency information and predetermined ranges or values, and a result of a comparison between the communication signal strength information of the first setting information and the communication signal strength information of the second setting information, or a comparison between the communication signal strength information and predetermined ranges or values.

24. The electronic device of claim 17, wherein the first setting information includes at least one piece of communication frequency information, communication signal strength information, and communication capability information,
the second setting information includes at least one piece of communication frequency information, communication signal strength information, and communication capability information, and
the electronic device selects one of a plurality of predetermined interference levels for indicating a degree of interference which a transmitted signal gives to a received signal based on at least one piece of the communication frequency information of the first setting information, the communication signal strength information of the first setting information, and the communication capability information of the first setting information, the communication frequency information of the second setting information, the communication signal strength information of the second setting information, and the communication capability information of the second setting information and limits the second communication operation of the second communication module based on the selected interference level.

25. The electronic device of claim 17, wherein the electronic device selects one of a plurality of predetermined interference levels for indicating a degree of interference which a transmitted signal gives to a received signal based on at least one piece of reception frequency information, received signal strength information, transmission frequency information, and transmitted signal strength information of the first and second setting information, compares the received signal strength information with at least one range or at least one value predetermined in connection with the selected interference level, and limits the second communication operation based on a result of the comparison.

26. The electronic device of claim 17, wherein the plurality of pieces of control information correspond to a plurality of predetermined interference levels for indicating a degree of interference which a transmitted signal gives to a received signal, a plurality of control commands or control values related to signal transmission or reception, or a plurality of limited conditions or allowed conditions related to the signal transmission or reception, and the limiting of the second communication operation corresponds to initiating signal transmission, stopping signal transmission, delaying signal transmission, controlling a transmitted signal strength, initiating signal reception, stopping signal reception, delaying signal reception, and controlling a received signal strength.

27. The electronic device of claim 17, wherein the plurality of pieces of control information correspond to a plurality of predetermined interference levels for indicating a degree of interference which a transmitted signal gives to a received signal, a plurality of control commands or control values related to signal transmission or reception, or a plurality of limited conditions or allowed conditions related to the signal transmission or reception, and the limiting of the second communication operation comprises transmitting, to the second communication module, an interference level selected from the plurality of interference levels, a control command or a control value selected from the plurality of control commands or control values, or a limited condition or an allowed condition selected from the plurality of limited conditions or allowed conditions.

28. The electronic device of claim 17, wherein the electronic device allocates a priority to each of the first communication module and the second communication module, and the first communication module has a higher priority than that of the second communication module.

29. The electronic device of claim 17, wherein the electronic device selects one of a plurality of predetermined interference levels for indicating a degree of interference which a transmitted signal gives to a received signal based on at least one piece of reception frequency information, received signal strength information, transmission frequency information, and transmitted signal strength information included in the first and second setting information, compares the received signal strength information with at least one range or at least one value predetermined in connection with the selected interference level, and limits the second communication operation based on a result of the comparison, and reception capability information predetermined in connection with the received signal strength information and the selected interference level.

30. The electronic device of claim 17, wherein the electronic device selects one of a plurality of predetermined interference levels for indicating a degree of interference which a transmitted signal gives to a received signal based on at least one piece of reception frequency information, received signal strength information, transmission frequency information, and transmitted signal strength information of the first and second setting information, determines a reception capability of the second communication operation based on reception capability information predetermined in connection with the received signal strength information and the selected interference level, compares the reception capability with at least one predetermined range or at least one value, and controls a signal reception operation of the second communication module based on a result of the comparison.

31. The electronic device of claim 17, wherein the electronic device selects an interference level corresponding to a maximum interference degree allowed in the first communication operation among a plurality of predetermined interference levels for indicating a degree of interference which a transmitted signal gives to a received signal, and controls a signal transmission operation of the second communication module based on a transmitted signal strength range allowed for the selected interference level.
